(19) United States
(12) Patent Application Publication
(10) Pub. No.: US 2025/0335568 A1
(43) Pub. Date: Oct. 30, 2025

(54) EMI ANOMALY DETECTION IN COMPUTER SYSTEMS USING ANTENNA IN EXPANSION CARD FORM FACTOR

(71) Applicant: ORACLE INTERNATIONAL CORPORATION, Redwood Shores, CA (US)

(72) Inventors: Gerard WARRENS, Gilbert, AZ (US); Robert J. B. DAVIS, Durham, NC (US); Andrew LEWIS, Litchfield, NH (US); Kenny C. GROSS, Escondido, CA (US); Guang Chao WANG, San Diego, CA (US); Alan WOOD, San Diego, CA (US); Joseph J. ERVIN, Stow, MA (US); Feng LI, La Jolla, CA (US); Daniel F. SIEVENPIPER, San Diego, CA (US)

(21) Appl. No.: 18/650,645

(22) Filed: Apr. 30, 2024

(51) Int. Cl. G06F 21/44; G01R 29/08; G06F 21/73

(52) U.S. Cl. CPC G06F 21/44; G01R 29/0871; G06F 21/73

(57) ABSTRACT

Systems, methods, and other embodiments associated with a specialized antenna expansion card for EMI fingerprint characterization of target computing systems are described. In one embodiment, a method for EMI scanning using a broadband antenna expansion card installed within a target computer includes causing the target computer to execute a test pattern of computer operations. The method includes taking readings of radiofrequency EMI generated by execution of the test pattern through the broadband antenna card that is installed within a chassis of the target computer. The method includes detecting that hardware of the target computer system is behaving anomalously based on a dissimilarity between the readings of radiofrequency EMI and machine learning estimates of radiofrequency EMI for nominal operation of a reference computer system. And, the method includes generating an electronic alert that the hardware of the target computer system is behaving anomalously.

### BACKGROUND

Computer systems such as servers and other electronic equipment may be operated with SpyChips or counterfeit components installed in them. Also, components of the computer systems may degrade over time. The presence of SpyChips, counterfeit components, or degraded components pose security and reliability concerns. In some cases, the presence of SpyChips, counterfeit components, or degraded components can be detected in a computer or other electronic system based on scans of electromagnetic interference (EMI) generated by the system. But, positioning, sensitivity, and configuration of the antenna used for an EMI scan can limit the detection effectiveness of the EMI scan.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates an example EMI monitoring system associated with use of a specialized fingerprinting antenna for EMI fingerprint characterization of computer systems.

FIG. 2 illustrates one embodiment of an EMI scanning method associated with a specialized fingerprinting antenna for EMI fingerprint characterization of computing systems.

FIG. 3 illustrates one embodiment of a printed circuit board (PCB) for a specialized fingerprinting antenna associated with EMI fingerprint characterization of computing systems.

FIG. 4 illustrates multiple views of an example PCB for a specialized fingerprinting antenna associated with EMI fingerprint characterization of computing systems.

FIG. 5 illustrates a three-dimensional (3D) view showing a primary surface of an example PCB for a specialized fingerprinting antenna associated with EMI fingerprint characterization of computing systems.

FIG. 6 illustrates a 3D view showing a secondary surface of an example PCB for a specialized fingerprinting antenna associated with EMI fingerprint characterization of computing systems.

FIG. 7 illustrates an exploded 3D view of an example PCB and an example frame for attachment to the PCB that are associated with a specialized fingerprinting antenna for EMI fingerprint characterization of computing systems.

FIG. 8 illustrates a top view of a secondary (reverse) side of the frame which is associated with a specialized fingerprinting antenna for EMI fingerprint characterization of computing systems.

FIG. 9 illustrates an east edge view of the frame which is associated with a specialized fingerprinting antenna for EMI fingerprint characterization of computing systems.

FIG. 10 illustrates an east edge view of a double-width frame for installation in a double expansion slot, which is associated with a specialized fingerprinting antenna for EMI fingerprint characterization of computing systems.

FIG. 11 illustrates an exploded 3D view of the PCB seated in and attached to the frame along with an I/O bracket and associated components for attachment to the frame and PCB, which are associated with a specialized fingerprinting antenna for EMI fingerprint characterization of computing systems.

FIG. 12 illustrates a 3D front view of an expansion card assembly that is associated with a specialized fingerprinting antenna for EMI fingerprint characterization of computing systems.

FIG. 13 illustrates a 3D rear view of the expansion card assembly that is associated with a specialized fingerprinting antenna for EMI fingerprint characterization of computing systems.

FIG. 14 illustrates a perspective view of an example target computer system having an antenna expansion card installed within a chassis of the computing system, which is associated with a specialized fingerprinting antenna for EMI fingerprint characterization of computing systems.

FIG. 15 illustrates a top view of the example target computer system having the antenna expansion card installed within the chassis of the computing system, which is associated with a specialized fingerprinting antenna for EMI fingerprint characterization of computing systems.

FIG. 16 illustrates a rear (west end) view of the example target computer system having the antenna expansion card installed within the chassis of the computing system, which is associated with a specialized fingerprinting antenna for EMI fingerprint characterization of computing systems.

FIG. 17 illustrates a first plot of return loss and a second plot of voltage standing wave ratio for an example EMI fingerprinting antenna associated with EMI fingerprint characterization of computing systems.

FIG. 18 illustrates a 3D gain plot and a 2D gain plot at a frequency of 2.6 GHz for the example EMI fingerprinting antenna associated with EMI fingerprint characterization of computing systems.

FIG. 19 illustrates a 3D gain plot and a 2D gain plot at a frequency of 1.2 GHz for the example EMI fingerprinting antenna associated with EMI fingerprint characterization of computing systems.

FIG. 20 illustrates an example EMI scanning system associated with specialized antenna for EMI fingerprint characterization of computing systems. The EMI scanning system includes a computing system configured with the example systems and/or methods disclosed.

### DETAILED DESCRIPTION

Systems, methods, and other embodiments are described herein that use a specialized antenna for electromagnetic interference (EMI) fingerprint characterization of computing systems. In one embodiment, a specialized fingerprinting antenna is provided in the form of an expansion card for installation in an expansion card slot of a computer system.

EMI scanning of computing systems has suffered from a number of disadvantages due to use of hand-held, general-purpose antennae to sense RF EMI given off by a target computer system being scanned. Hand-held antennae lack repeatability of positioning and require physical manipulation (e.g., opening the chassis) of the target computer to perform a scan. These activities introduce variability or uncertainty into EMI scan results, limiting the accuracy of EMI fingerprint analyses.

In one embodiment, performing EMI scanning using a specialized broadband antenna constructed in the form of an expansion card resolves these and other challenges. The broadband antenna card is configured to mechanically register on an expansion connector in an expansion slot of the target computer and support the antenna PCB within the expansion slot. The broadband antenna card may thus be physically installed in a repeatable and consistent position inside a plurality of target computers. The broadband antenna card operates as a radiofrequency probe to sense RF EMI occurring within the chassis of an individual computer, but remains external to the computing operations of the computer system.

In one embodiment, the broadband antenna card is used for performing an EMI fingerprint scanning method. A target computer having a broadband antenna card installed is run in a test pattern, and readings of the resulting EMI are taken through the broadband antenna card. The readings of the EMI are analyzed to determine whether the EMI indicates that the target computer is compromised. If the target computer is compromised (such as by having a spychip, a counterfeit component, or a failing component) is detected, an electronic alert will be generated.

In one embodiment, a broadband antenna card may be connected through a radio receiver to an EMI scanning computer. The radio receiver and EMI scanning computer are configured as a portable test rig for performing the EMI fingerprint scanning method on a target computer, for example while the target computer remains in-situ. In one embodiment, one or more broadband antenna cards are connected though a RF switch and/or one or more radio receivers to the EMI scanning computer. The radio receiver, switch, and EMI scanning computer are configured as an in-situ (e.g., rack-mounted) EMI monitoring system for performing the EMI fingerprint scanning method on one or more target computers having the broadband antenna cards installed.

### Definitions

As used herein in reference to a device (such as a computing device or other electronic device), the term “target” indicates that the device is a subject of observation by a fingerprinting antenna.

As used herein with reference to PCBs and expansion cards, cardinal compass directions are used to refer to various edges of a PCB or expansion card. In this convention: (i) a first edge of the PCB/card configured for access by I/O connections (such as RF connector 320) to the exterior of a computer chassis may be referred to herein as a “west” edge (or alternatively, an “outer” or “exterior-facing” edge); (ii) a second edge of the PCB/card that is configured to be most proximate to an edge connector for interfacing with a motherboard may be referred to herein as a “south” edge (or alternatively, a “lower” or “board-facing” edge); (iii) a third edge of the PCB/card that is configured to be opposite to the edge connector for interfacing with the motherboard may be referred to herein as a “north” edge (or alternatively, an “upper” edge); and (iv) a fourth edge of the PCB/card that is configured to be opposite the to the I/O connections, for example the edge that extends furthest into the interior of the chassis, may be referred to herein as an “east” edge (or, alternatively, an “interior-facing” or “free” edge).

As used herein with reference to PCBs, expansion cards, and computer chassis, the terms “lateral” and “laterally” refer to position or movement from side to side of a long axis of an expansion slot, expansion card, or side to side of primary to secondary surfaces of a PCB.

As used herein, the term “substantially” with reference to parallel, perpendicular, or other orientations refers to an approximation of the stated orientation within given manufacturing tolerances, for example tolerances applicable or acceptable in devices for installation in expansion slots of a computer.

As used herein, the term “communicably coupled” refers to a connection or interface between two components that enables data or signals to pass between or through each other.

As used herein, the terms “time series” and “time series signal” refer to a data structure in which a series of data points or readings (such as observed or sampled values) are indexed in time order. For convenience, a time series signal may be referred to herein simply as a “signal”. In one embodiment, the data points of a time series may be indexed with an index such as a point in time described by a time stamp and/or an observation number. A time series may be considered one “column” or sequence of data points over multiple points in time from one of several data sources. For example, a time series is one column or sequence of observations over time from one of N variables (such as from one frequency bin of a frequency spectrum).

As used herein, the term “vector” refers to a data structure that includes a set of data points or readings (such as observed or sampled values) from multiple time series at one particular point in time, such as a point in time described by a time stamp, observation number, or other index. A vector may therefore be considered one “row” of data points sampled at one point in time from each of several data sources. For example, a vector is one row or set of observations from all N variables (such as from multiple frequency bins of a frequency spectrum).

As used herein, the term “time series database” refers to a data structure that includes multiple time series that share an index (such as a series of points in time, time stamps, time steps, or observation numbers) in common. From another perspective, the term “time series database” refers to a data structure that includes vectors across multiple time series at a series of points in time, that is, a time series of vectors. As an example, time series may be considered “columns” of a time series database, and vectors may be considered “rows” of a time series database. A time series database is thus one type of a set of time series readings. For example, amplitude values recorded from multiple frequency bins of a frequency spectrum at successive points in time may be indexed in order of a time associated with the amplitude values, thus making a time series database of the amplitude values.

As used herein, the term “residual” refers to a difference or error between corresponding values in a pair of time series signals. For example, a residual may be a difference between an actual value (such as a measured, observed, sampled, or resampled value) for an index position and an estimate, reference, or prediction of what the actual value is expected to be at the index position. For example, a residual may be a difference between an actual, observed value and a machine learning (ML) prediction or ML estimate of what the value is expected to be by an ML model. Or, for example, a residual may be a difference between two actual values at corresponding index positions in a pair of time series signals. For example, a residual may be a difference between actual values observed from two different systems, such as a reference computer system and a target computer system. In one embodiment, the residual may be an unsigned magnitude of the difference, also referred to as an “absolute error.” In one embodiment, a time series of residuals or “residual time series” refers to a time series made up of residual values between a time series of values and a time series of what the values are expected to be.

### —Example EMI Monitoring System—

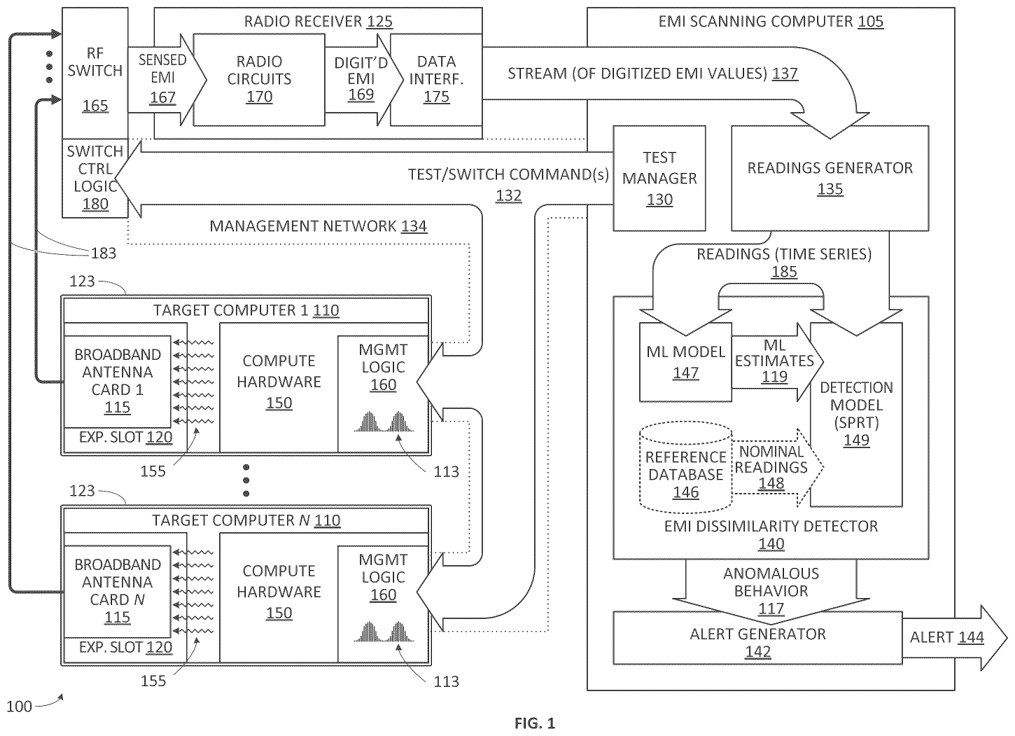

FIG. 1 illustrates an example EMI monitoring system 100 associated with use of a specialized fingerprinting antenna for EMI fingerprint characterization of computer systems. EMI monitoring system 100 includes an EMI scanning computer 105, a target computer 110, a broadband antenna card 115 (such as antenna expansion card 1205) installed in an expansion slot 120 within chassis 123 (or housing) of the target computer 110, and a radio receiver 125 that is electrically connected to broadband antenna card 115 and communicably coupled to the EMI scanning computer 105. In one embodiment, there are a plurality of target computers 110, each with their own broadband antenna card 115 installed in an expansion slot 120.

In one embodiment, example EMI monitoring system 100 is implemented as a data center installation. In the data center, there are a plurality of target computers 110 that are servers. The servers may be installed in racks in the data center. The servers each have a broadband antenna card 115 installed in an expansion slot 120. A broadband antenna card 115 is an EMI probe for collecting EMI 155 occurring within the individual server in which the broadband antenna card 115 is installed. The plurality of broadband antenna cards 115 are connected (e.g., through an RF switch 165) to a radio receiver 125. Radio receiver 125 processes electrical signals induced by the EMI 155 into a digital data stream 137. The data stream 137 is analyzed by an EMI scanning computer 105 to detect onset of EMI anomalies in the server. The radio receiver 125 and EMI scanning computer 105 may also be installed in the racks of the data center. The installed broadband antenna cards 115, radio receiver 125, and EMI scanning computer 105 thus form an in-situ EMI scanning solution for monitoring individual servers for EMI anomalies, such as those EMI anomalies caused by incipient component failure, installation of counterfeit components, or operation of spychips (or other eavesdropping or data interception devices such as wiretaps or bugs).

In one embodiment, example EMI monitoring system 100 uses broadband antenna cards for occasional and/or ongoing EMI fingerprint characterization of target computer systems 110. As used herein, an EMI fingerprint is a signature that characterizes EMI 155 produced by a computer system 110 during execution of a given test pattern 113 of operations. In one embodiment, the EMI fingerprint specifically characterizes the EMI for the particular configuration of hardware in the target computer system 110. In one embodiment, to generate the EMI fingerprint, the processor performs a time-domain to frequency-domain to time-domain double transformation of EMI 155 given off by the target computer system 110 and sensed by the installed broadband antenna card 115. The EMI fingerprint for the target computer system is then formed from time-series of amplitude values in pre-selected frequency bins.

In one embodiment, a reference EMI fingerprint is formed from a specimen of a particular hardware configuration of computer system for which the state of hardware degradation is known, referred to occasionally herein as a reference computer system. In one embodiment, the reference computer system is a “golden sample”—a computer system having the particular hardware configuration that is confirmed to be free of spychips and counterfeit components, and which is confirmed to be in an undegraded or nominal state of degradation. For the reference EMI fingerprint, the set of frequency bins selected for sampling into the reference EMI fingerprint are those that most correspond to the test pattern 113, and therefore are the salient frequency bins that carry the most information about the operations of the reference computer system. In one embodiment, a reference EMI fingerprint is formed from these salient frequencies. For other specimens of the particular hardware configuration for which the state of degradation is unknown and/or the presence or absence of spychips is unknown, a target EMI fingerprint is formed from the salient frequency bins. The target and reference EMI fingerprints may be compared, for example by performing multivariate anomaly detection on the target EMI fingerprint using an ML model trained using the reference fingerprint.

Use of the broadband antenna card increases the accuracy of the EMI fingerprints and anomaly detection by engaging with the reference computer system in a position—e.g., a particular expansion slot 120. The engagement renders positioning repeatable in other target computer systems sharing the same configuration as the reference computer system, allowing consistent comparison between reference and target computer systems. Further, the installation reduces vibration-induced variabilities in the scans. EMI fingerprint characterization and counterfeit/spy chip (or other anomaly) detection using the broadband antenna card is therefore subject to lower missed alarm probabilities (MAPs) and lower false alarm probabilities (FAPs).

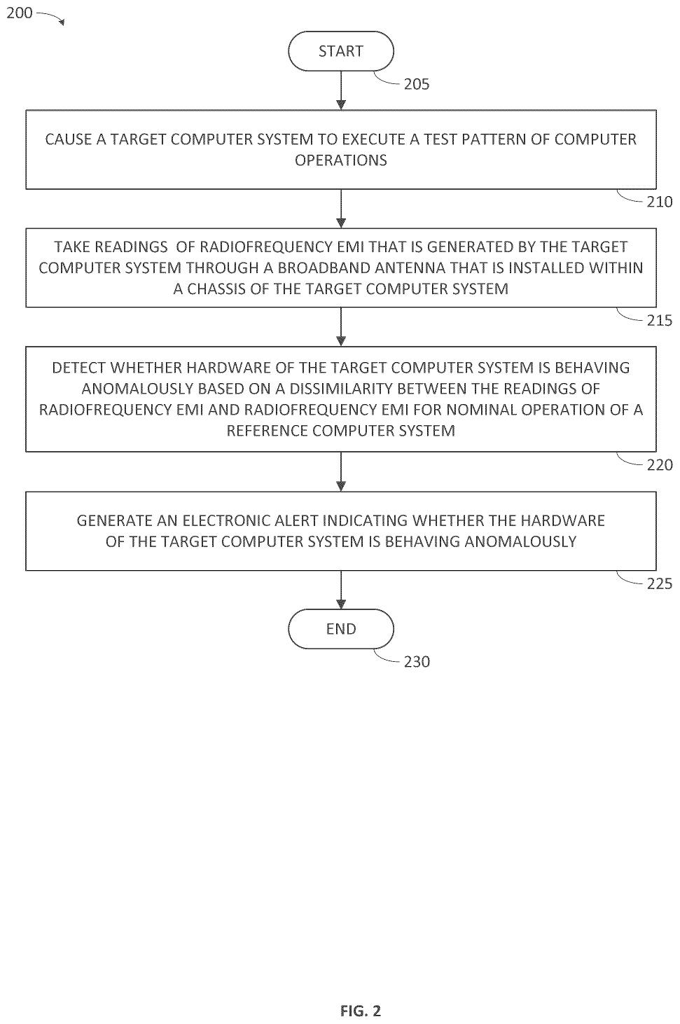

Further details regarding EMI monitoring system 100 are presented herein. In one embodiment, features of target computers 110, radio receiver 125, and EMI scanning computer 105 will be described with further reference to FIG. 1. In one embodiment, operations of EMI monitoring system 100 will be described with reference to method 200 of FIG. 2.

### —Example EMI Monitoring System-Target Computers—

Target computer(s) 110 include compute components 150 configured to execute computing tasks, such as server tasks of providing services, data, or computing resources to client computers. Compute components 150 radiate EMI 155 when operating. A broadband antenna card 115 installed within chassis 123 of the target computer 110 is configured to sense EMI 155. Broadband antenna card 115 physically registers on mechanical features of expansion slot 120 to enable consistent and repeatable positioning of broadband antenna card 115 within chassis 123.

Compute components 150 include management logic 160. Management logic 160 is configured to operate target computer 110 in a test pattern 113. In one embodiment, the management logic 160 is system control hardware that is embedded in a target computer 110, such as the Oracle® integrated lights out manager (ILOM). Management logic 160 is configured to exercise control over the target computer 110, for example to execute remote administration, diagnosis, and maintenance tasks.

Management logic 160 is configured to communicate though and receive commands though management network 134, for example using a dedicated network interface. Management network 134 is in a separate plane from general network traffic, and used for out-of-band communication with management logic 160. Test manager 130 may transmit test commands 132 over management network 134 to management logic 160.

In one embodiment, in response to receiving one or more of test commands 132, management logic 160 causes compute components 150 to operate in accordance with the test pattern 113. In one embodiment, the test pattern 113 is stored in local memory or storage of management logic 160. In one embodiment, the test pattern 113 defines a compute load to be placed on (that is, executed by) compute components 150. For example, the test pattern 113 may be executable, such as a script or binary.

In one embodiment, the test pattern 113 is configured to cause the compute components 150 to vary the utilization of one or more of the compute components 150 over time in a predetermined manner. This places a changing or dynamic workload on the target computer 110. For example, the utilization of the compute components 150 may be varied between a minimum (or idle) utilization state and a maximum utilization state over the period of time. In one embodiment, the test pattern 113 increases and decreases the utilization in a sinusoidal pattern. In one embodiment, the utilization may be varied by pulse-width-modulation (PWM) load profiling. PWM load profiling modulates the utilization of the compute components 150 by switching execution of a task between a stop state, in which execution of the task is suspended, and a run state, in which the task is executed. In one embodiment, the test pattern may be a loop of changes in utilization that may be repeated indefinitely over the course of a test. In one embodiment, test manager 130 is configured to update test pattern 113 from time to time, for example by transmitting updated versions of the test pattern 113 to management logic 160.

### —Example EMI Monitoring System-Radio Receiver—

In one embodiment, radio receiver 125 includes components configured to accept EMI 155 that is sensed by a broadband antenna card 115 (also referred to as sensed EMI 167) and convert it to a stream of digitized EMI values 137. In one embodiment, radio receiver 125 includes an RF switch 165, radio circuits 170, a data interface 175, and a switch control logic 180 configured to operate radio receiver 125. Broadband antenna card(s) 115 are connected by feedlines 183 to input ports of radiofrequency switch 165.

In one embodiment, radio receiver 125 is integrated with radiofrequency switch 165 in one unit. In another embodiment, radiofrequency switch 165 is a stand-alone unit that is separable from radio receiver 125, for example in configurations where radio receiver 125 is an expansion card/device installed in EMI scanning computer 105.

Radiofrequency switch 165 is configured to selectively route radiofrequency signals between various input and output ports. In one embodiment, radiofrequency switch 165 uses sold-state components (such as PIN diodes or field effect transistors (FETs)) to route sensed EMI 167 through from one of the input ports to one of the output ports. Feedlines 183 are connected between output radiofrequency connectors of broadband antenna cards 115 and input radiofrequency connectors of radiofrequency switch 165. Input and output radiofrequency connectors of radiofrequency switch 165 are connectors to input and output (respectively) ports of radiofrequency switch 165. In one embodiment, an output port of radiofrequency switch 165 is connected (e.g., by a further feedline) to an antenna input of radio circuits 170.

In one embodiment, radiofrequency switch 165 is configured to select one antenna among broadband antenna cards 115 to connect through to radio circuits 170. Thus, radiofrequency switch 165 is configured to direct sensed EMI 167 from a selected one of broadband antenna cards 115 to an antenna input of radio circuits 170. In one embodiment, RF switch 165 includes multiple output ports, and radio receiver 125 includes multiple radio circuits 170. This enables parallel monitoring of EMI 155 received from a plurality of broadband antenna cards 115, each of which antenna cards 115 are respectively installed in discrete target computer 110.

Radiofrequency switch 165 includes switch control logic 180. Switch control logic 180 is configured to automatically configure routing through radiofrequency switch 165. In response to receiving instructions that designate particular input and output ports, switch control logic 180 automatically connects a designated input port to a designated output port. In this way, connections between an input port associated with a particular broadband antenna card 115 to an output port associated with radio circuits 170 may be automated. Switch control logic 180 is configured to communicate over and receive commands from management network 134.

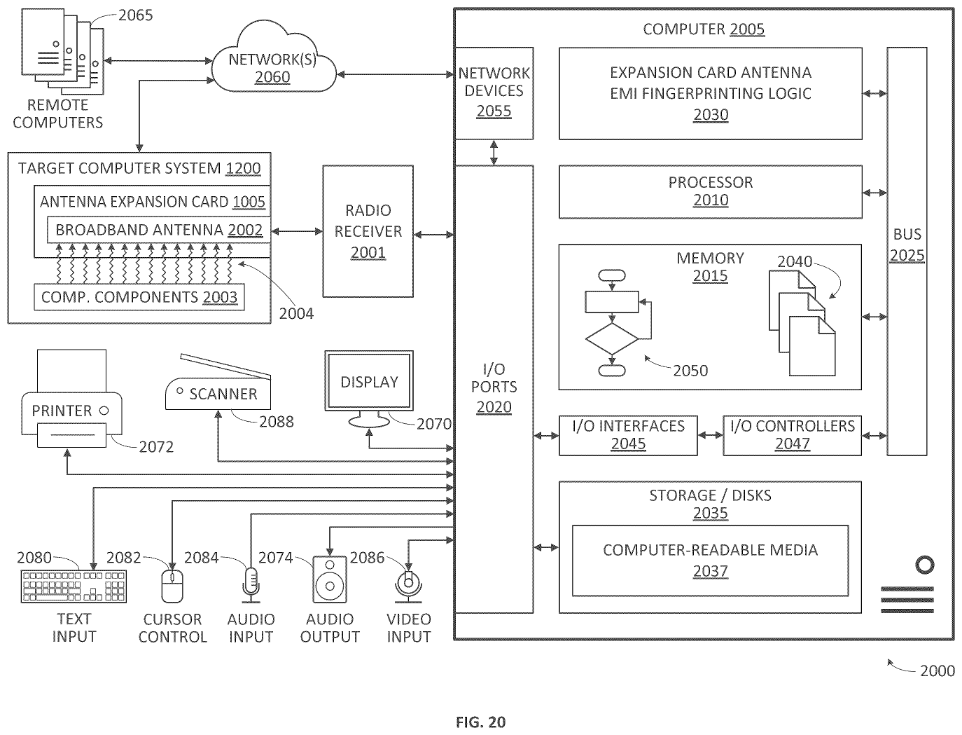

As discussed in further detail below with reference to FIG. 20, radio circuits 170 may be a software defined radio (SDR). In one embodiment, radio circuits 170 may include one or more integrated circuits incorporating some or all of the components of radio circuits 170. Radio circuits 170 implement a radiofrequency chain for reception, processing, and demodulation of sensed EMI 167. In one embodiment, radio circuits 170 include a local oscillator and a demodulator. In one embodiment, the local oscillator generates a stable reference signal at a given or specified frequency, allowing specific frequencies of the broadband spectrum to be analyzed for EMI content. Local oscillator may also be employed with a frequency synthesizer that is configured to produce multiples of the reference signal.

Because radio receiver 125 is configured to detect and record sensed EMI 167 rather than extract an information signal from a carrier wave, the function of the demodulator differs significantly from demodulating a traditional modulated carrier wave. Instead of extracting an information signal, in one embodiment, the demodulator is configured to capture and analyze frequency, amplitude, waveform, and/or temporal characteristics of the sensed EMI 167 across the frequency spectrum. The demodulator captures the raw RF signals of the sensed EMI 167, including broadband noise, spikes, or transient disturbances.

The demodulator (or other post-processing digitizing logic) may generate records of the sensed EMI 167, such as digitized EMI 169. In one embodiment, digitized EMI 169 are data structures recording broad-spectrum amplitude values of sensed EMI 167. In one embodiment, the digitized EMI 169 may be produced as a series of time-stamped observations, or a time series of broad-spectrum readings of sensed EMI 167. In one embodiment, the digitized EMI 169 may be stored (temporarily) in memory of radio receiver 125.

In one embodiment, data interface 175 is configured to access digitized EMI 169, package digitized EMI 169, and transmit digitized EMI 169 as a stream 137 (of digitized EMI 169 values) to readings generator 135. In one embodiment, data interface 175 is an ethernet interface. For example, ethernet of 1 Gbps may be acceptable (although higher speeds such as 10 Gbps (or higher) may be preferable) for transferring digital RF readings of a wide frequency range. In one embodiment, data interface 175 is a USB interface. For example, USB 3.0 (or higher) can provide sufficient bandwidth for transferring digital RF readings of a wide frequency range. In one embodiment, data interface 175 is a PCIe or other expansion. Other data interfaces having sufficiently rapid data transfer rates to carry keep pace with the stream 137 of digitized EMI 169 may also be used. In one embodiment, radio receiver 125 is a stand-alone unit connected by ethernet or other networks to EMI scanning computer 110. In one embodiment, radio receiver 125 is an expansion card that is installed in and in communication with EMI scanning computer 110 (e.g., through a PCIe bus or USB).

### —Example EMI Monitoring System-EMI Scanning Computer—

In one embodiment, EMI scanning computer 105 includes components configured to detect anomalous EMI emission by target computer 110 using installed broadband antenna card 115. For example, EMI scanning computer 105 is configured to perform a method to detect hardware anomalies in a target computer 110. The components are configured to detect the anomalies using EMI 155 collected by broadband antenna card 115 and received by radio receiver 125 during execution of a test pattern 113 by the target computer 110.

EMI scanning computer 105 includes test manager 130, readings generator 135, EMI dissimilarity detector 140, and alert generator 145. Test manager 130 is configured to cause a target computer 110 to execute a test pattern 113 of computer operations. Readings generator 135 is configured to take readings 185 of radiofrequency EMI 155 through the broadband antenna card 115 that is installed within the chassis 123 of the target computer 110. The radiofrequency EMI 155 is generated by compute hardware 150 of the target computer 110 during execution of the test pattern 113. EMI dissimilarity detector 140 is configured to detect that compute hardware 150 of the target computer system 110 exhibits anomalous behavior 117. The detection is based on a dissimilarity between the readings 185 of radiofrequency EMI 155 and machine learning estimates 119 of radiofrequency EMI for nominal operation of a reference computer system. Alert generator 142 that is configured to generate an electronic alert 144 that the compute hardware 150 of the target computer 110 is behaving anomalously.

In one embodiment, test manager 130 is configured to cause target computer(s) 110 to execute a test pattern 113 of computer operations. In one embodiment, test manager 130 is configured to automatically initiate execution of the test pattern 113 in the target computer 110. And, in one embodiment, test manager 130 is configured to automatically initiate EMI scanning of the target computer 110. For example, test manager 130 may be configured to initiate execution of the test pattern 113 on and EMI scanning of the target computer 110 on a schedule, such as a repeated schedule.

Test manager 130 is configured to automatically initiate the execution of the test pattern 113 in the target computer 110 by transmitting a test command 132 to management logic 160 of the target computer system 110. For example, test manager 130 is configured to generate and issue test commands 132. Test command(s) 132 includes computer-executable instructions that are configured to cause management logic 160 of a target computer 110 to initiate execution of test pattern 113 in the target computer 110. Test command(s) 132 may include a designation of which of a plurality of target computers 110 the test command(s) 132 is intended. In one embodiment, test manager 130 is connected to and configured to communicate over management network 134. And, test manager 130 transmits the test command(s) 132 to management logic 160 by way of the management network 134.

Test manager 130 may also be configured to automatically trigger RF Switch 165 to direct sensed EMI 167 from a particular target computer 110 into radio circuits 170. Test commands 132 may also include instructions that are configured to cause the radio receiver 125 to monitor the EMI 155 produced by execution of the test pattern 113 in the particular target computer 110. For example, test manager may generate and issue test command(s) 132 instructing switch control logic 180 to configure RF switch 165 to feed the sensed EMI 167 from a particular broadband antenna card 115 installed in the particular target computer 110 to the radio circuits 125. The instructions thus switch radio receiver 125 to monitoring the particular broadband antenna card 115 of the target computer 110 that is under test. In one embodiment, test manager 130 transmits the test command(s) 132 to switch control logic 180 by way of the management network 134.

In one embodiment, readings generator 135 is configured to take readings 185 from the radio receiver 125 of EMI 155 sensed by the broadband antenna card 115 within the chassis of the target computer 110 during execution of the test pattern. In other words, readings generator 135 is configured to generate a target EMI fingerprint—a time series of readings for the pre-selected frequency bins—from the stream 137 of digitized, sensed EMI. In one embodiment, readings generator 135 is configured to accept a stream 137 of digitized EMI values from radio receiver 125. In one embodiment, readings generator 135 converts the stream 137 of digitized broadband EMI values into a time series of the readings 185 of selected frequencies within the broadband range. Because readings 185 are taken from stream 137 (of digitized EMI 169 generated by radio circuits 170 from sensed EMI 167 detected by broadband antenna cards 115 from the EMI 155 given off by computer components 150 that are executing the test pattern) the readings 185 may be described simply as readings of EMI 155 sensed by the broadband antenna during execution of the test pattern. Further, as broadband antenna cards 115 are installed within expansion slots 120, the EMI 155 are sensed within the chassis of the target computer 110.

In one embodiment, to take the readings 185, readings generator 135 is configured to (i) divide a broadband spectrum of the radiofrequency EMI 155 into a plurality of frequency bins, and (ii) sample amplitude values from a plurality of the frequency bins that are pre-determined to be representative of the reference computer system to form the readings 185 of the radiofrequency EMI 155. The readings 185 are formatted as a multivariate time series of the amplitude values from the pre-selected frequency bins.

In one embodiment, to convert the stream 137 to readings 185, readings generator 135 is configured to perform a Fast Fourier Transform (FFT) on the digitized EMI values in stream 137 in a moving window. The FFT produces a power spectral density (PSD) for the window. Readings generator 135 is configured to record an observation of amplitude values for a plurality of pre-selected frequency bins (ranges of contiguous frequencies) in the PSD curve. The observation of the amplitude values for the pre-selected frequency bins is recorded as a multivariate reading 185 of the radiofrequency EMI 155. For example, a reading includes observations of the amplitude values for the pre-selected frequency bins of a PSD for a window of time, and a time stamp for the reading 185.

In one embodiment, the pre-selected frequency bins are subset of bins that exhibit greatest correlation to the test pattern when the test pattern is executed on a reference or “golden” computer system. The reference computer system is a computer system that represents a nominal operating state for a particular configuration of computer system. For example, the reference computer system is confirmed to be composed of undegraded components, and confirmed to be free of counterfeit components and spychips. In one embodiment, computer systems in the particular configuration have a set of components of particular types (i.e., make and model) in common, with the particular types of components installed in same physical positions within the computer systems. In one embodiment, the broadband antenna card 115 is installed in a same expansion slot in the computer systems having the particular configuration. There may be a wide variety of configurations of computer systems, each having differing sets of components or differing positions for the components. Use of the broadband antenna in expansion card format to take EMI readings provides positioning consistency between reference and target computing systems, enabling increased sensitivity and accuracy of anomaly detection between the reference and target EMI readings.

A set of reference EMI readings for the particular configuration of the target computer 110 may be obtained from execution of the test pattern by the reference computer system having the particular configuration. The reference EMI readings may be sensed using a broadband antenna card 115 installed in a given expansion slot of the reference computer system in accordance with the particular configuration. The EMI given off by the reference computer system is representative of expected, appropriate, or otherwise “correct” operation of computer systems having the particular configuration. The frequency bins that are pre-selected for monitoring have amplitude changes that most closely correspond to the changes in utilization caused by executing the test pattern 113 on the reference computer system. Correspondence between the frequency bins and test pattern 113 may be determined and ranked based on cross-correlation coefficients between the test pattern 113 and activity in the frequency bins. For example, the top 20% of bins in terms of correlation with the test pattern 113 may be pre-selected for inclusion in the readings 185. These pre-selected bins may be considered to carry a highest amount of information for detecting differences from the nominal operating state.

In one embodiment, the time stamp for the reading is a time stamp related to the window of time for the PSD from which the reading is taken, such as of a beginning, end, or middle of the window of time. In one embodiment, readings generator 135 is configured to append individual readings 185 to a time series data structure. In the time series of the readings 185, individual readings are collected in order of time stamp. In one embodiment, the time series of the readings 185 has a sampling interval longer that of stream 137. For example, the time series may be sampled at a rate of a few observations per second, such as 10 observations per second, or 1 observation per second, or even lower. In one embodiment, the moving window is sized so as to cover the sampling interval between observations of the time series of readings 185.

Thus, in one embodiment, taking readings of the radiofrequency EMI includes dividing a broadband spectrum of the radiofrequency EMI into a plurality of frequency bins. Thus, in one embodiment, taking readings of the radiofrequency EMI includes sampling amplitude values from a plurality of the frequency bins that are pre-selected to be representative of the reference computer system to form the readings of the radiofrequency EMI. The readings are formatted as multivariate time series of the amplitude values from the plurality of frequency bins.

In one embodiment, EMI dissimilarity detector 140 is configured to detect that hardware of the target computer system is behaving anomalously. The detection is based on a dissimilarity between the readings 185 of radiofrequency EMI 155 and machine learning estimates 119 of radiofrequency EMI for nominal operation of a reference computer system. In one embodiment, EMI dissimilarity detector 140 includes a machine learning model 147 and detection model 149. In one embodiment, EMI dissimilarity detector 140 includes a reference database 146 and detection model 149. Reference database 146 includes nominal readings 148 generated from EMI sensed in a reference computer system that has a same or similar hardware configuration to the target computer system. The nominal readings 148 may be: (i) used to train ML model 147 to generate ML estimates 119 for provision to the detection model 149 as a reference for comparison with readings 185; or (ii) provided directly to the detection model 149 as a reference for comparison with readings 185.

ML Estimation. In one embodiment, machine learning model 147 is a multivariate state estimation model. Machine learning model 147 is configured to output an estimate of the expected value for each variable based on input values for other variables. For example, for Signal 1 in a database of N signals, the ML model 147 will compute an estimate for Signal 1 using signals 2 through N, and so on. Machine learning model 147 is configured to accept an input amplitude value for each of the pre-selected frequency bins, and generate an output estimated amplitude value for each of the pre-selected frequency bins. For example, machine learning model 147 is configured to accept a vector of readings 185, and produce a corresponding vector of ML estimates 119 of what the readings 185 are.

In one embodiment, the ML model may be a non-linear non-parametric (NLNP) regression algorithm configured to perform state estimation of multiple variables. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, the ML model may be another form of algorithm used for state estimation of multiple variables, such as a neural network (NN), Support Vector Machine (SVM), or Linear Regression (LR).

Machine learning model 147 is trained to produce estimates that are consistent with nominal operation of a reference computer. Training is performed with time series readings (such as nominal readings 148) collected from a reference computer system, and which represent normal, correct, undegraded, or otherwise nominal operation of the reference computer system. The training process involves iteratively optimizing a configuration of the ML model 147 until the ML model 147 consistently predicts expected values for the training portion of the individual signal that match (within an acceptable tolerance) target values for the output of the ML model. During the training, the target value for the output from the ML model 147 for a variable is the value provided as the input to the ML model 147 for the variable.

To train the ML model 147, the target values and time series readings are used to adjust the ML model 147. In particular, a configuration of correlation patterns between the input variables of the ML model is automatically adjusted based on current values of the time series readings and the target values. The automatic adjustment causes the ML model 147 to produce estimates from input values of the time series readings that approximate the target values within the acceptable tolerance, that is, with sufficient accuracy to satisfy a threshold for concluding that the ML model 147 is trained. In one embodiment, sufficient accuracy of estimates to conclude the ML model 147 is trained may be determined by residuals between estimates and target values for the respective variables being minimized below a pre-configured training threshold. Here, a residual (as discussed above) is a difference between an actual value (such as a measured, observed, sampled, or resampled value) and an estimate, reference, or prediction of what the value is expected to be. At the completion of training, the ML state estimation model has inferred (learned) correlation patterns between variables.

Anomaly Detection. In one embodiment, overall, EMI of two computer systems (e.g., reference and target) may be compared to understand whether the two computer systems differ in some substantive way. The radiofrequency EMI readings of the reference and target computer systems may be recorded, and then compared to characterize dissimilarity between the readings of EMI for the target computer system and the reference computer system. The EMI readings from the reference computer system are considered to represent nominal operation for computer systems of a given type. As discussed above, in one embodiment, the EMI readings represent the behavior of the computer systems during execution of a predetermined test pattern.

In some situations, dissimilarities between the EMI readings of a reference computer system and a target computer system may be continuous, or in a steady state. This is the case where a spychip or counterfeit component is installed in the target computer system. The EMI of a target computer system having a spychip or counterfeit component differs from the nominal EMI of the reference computer system in a pattern that is consistent over time. In other situations, dissimilarities between the EMI readings of a reference computer system and a target computer system may be initially absent, and occur and/or increase over time. This is the case where one or more components of a target computer system fail or degrade in performance over time. The EMI of a target computer system with a failed or degrading component will suddenly or gradually diverge from the nominal EMI of the reference computer system over time.

In one embodiment, ML estimates 119 generated by trained ML model 147 from readings 185 may be used by detection model 149 to detect whether the EMI 155 emitted by compute hardware 150 is anomalous. Or, in one embodiment, nominal readings 148 previously recorded (e.g., in reference database 146) from the reference computer system may be used by detection model 149 to detect whether the EMI 155 emitted by compute hardware 150 is anomalous. In one embodiment, the readings 185 are a time series of vectors of actual amplitude values read from the target computer system at the pre-selected frequency bins—an EMI fingerprint of the target computer. And, ML estimates 119 are a time series of vectors of estimated amplitude values generated as a reference signal by the model for the pre-selected frequency bins from the actual amplitude values of the readings 185. Nominal readings 148 are a time series of vectors of actual amplitude values previously read as a reference signal from the reference computing device at the pre-selected frequency bins. The reference signal (either ML estimates 119 or nominal readings 148) and readings 185 correspond by time stamp, forming pairs of actual and reference values for the pre-selected frequency bins. The time series of corresponding actual and reference values may be compared by detection model 149 to detect anomalous departures from nominal behavior.

For example, the presence of an anomaly in a time series of values for a frequency bin may be detected by a sequential probability ratio test (SPRT) or cumulative sum test (CUSUM) analysis of the actual and reference (nominal or estimated) values. Other anomaly detection models may also be used. In one embodiment, the SPRT calculates a cumulative sum of the log-likelihood ratio for each successive residual between an actual value and a reference value for the frequency bin. The SPRT then compares the cumulative sum against a threshold value indicating anomalous deviation. Where the threshold is crossed, an anomalous behavior 117 of the compute hardware 150 has been detected in the particular frequency bin of EMI 155.

In one embodiment, detection of anomalous differences between readings 185 and ML estimates 119 is satisfactory for detection of both (i) steady state (i.e., continual pattern of difference over time) anomalies such as the presence of spychips or counterfeit components and (ii) dynamic (i.e., changing pattern of difference over time) anomalies such as the onset of failure or degradation of components. In one embodiment, detection of anomalous differences between readings 185 and the nominal readings 148 is satisfactory for detection of steady state anomalies, but may have limited application to dynamic anomalies.

EMI dissimilarity detector 140 may record features of the anomalous behavior 117. For example, EMI dissimilarity detector 140 may store in a data structure (i) a frequency bin in which the anomaly is occurring, (ii) an extent to which the expected and actual values deviate, and (iii) timestamps at which the anomaly is occurring.

In one embodiment, EMI dissimilarity detector 140 is configured to analyze the readings 185 for similarity with known anomaly types. EMI dissimilarity detector 140 may be configured to detect that the target computer system 110 is compromised in a particular way. The detection is based on similarity between the readings 185 of the radiofrequency EMI 155 and other machine learning estimates of radiofrequency EMI for operation of the reference system when compromised in the particular way. EMI dissimilarity detector 140 is configured to access a library of ML models of the RF EMI “symptoms” given off by specific types of known anomalies. The library may include symptom ML models trained with RF EMI from a reference computer that is not a golden sample, and is known to have a particular type of bad component. For example, the symptom ML models may be trained using RF EMI from a reference device known to have a particular type of spychip, or known to have a failing memory module, or known to have a counterfeit microprocessor. EMI dissimilarity detector 140 is configured to generate other ML estimates using the symptom ML model, and comparing the other ML estimates to the readings 185 with the detection model 149. If no anomaly is detected between the other ML estimates and the readings 185, the target 110 is likely compromised in the same way as the compromised reference system. EMI dissimilarity detector 140 may record the match to a known type of anomaly as a feature of the anomalous behavior 117.

In one embodiment, where no symptom ML model produces estimates consistent with readings 185, EMI dissimilarity detector 140 may record the target 110 to be compromised in a way that is unrecognized, not known, or not recorded in the library. And, EMI dissimilarity detector 140 may further be configured to train a new symptom machine learning model for detection of the unrecognized way based on the readings 185 of radiofrequency EMI 155. The new symptom machine learning model may then be added to the library and propagated to other EMI scanning systems. Other target computer systems may then be detected (in the manner described herein) to be compromised in the previously unknown way.

In this way, the library of symptom ML models may be continually updated with newly discovered spychip installations, counterfeit component installations, and component failure modes. Due to the readings 185 being sourced using the broadband antenna card 115, the variability of positioning is removed from the EMI profiles or “fingerprints” of the systems. The consistent positioning of the broadband antenna card 115 improves the applicability of the EMI profiles for detection in other computing devices having similar or same physical layouts. The consistent and repeatable positioning allows increased accuracy in EMI-based detection of counterfeit components, spychips, component degradation, or other anomalies. First, tolerances for detection may be tightened because there is no longer a need to account for variable positioning, thereby reducing missed alarms. Second, the readings are rendered more consistent from unit to unit by the consistent and repeatable positioning such that inconsistent readings are more likely to be due to anomalies, thereby reducing false alarms.

Alert generator 142 is configured to generate an electronic alert 144 that the compute hardware 150 of the target computer system 110 is behaving anomalously. In one embodiment, an electronic alert 144 is generated by composing and transmitting a computer-readable message. In one embodiment, an electronic alert 144 may be generated and sent in response to a detection of an anomalous value in the readings 185. The anomalous behavior 117 may be composed and then transmitted for subsequent presentation on a display, or for other action.

The electronic alert 144 may include message content describing the anomalous behavior 117 that triggered the alert. For example, alert generator 142 may be configured to specify, (i) timestamp(s) at which the anomalous behavior 117 was detected, (ii) an indication of the values that caused the anomaly, (iii) an identification of a frequency bin in which the anomalous behavior 117 occurred, and (iv) a particular target computer 110 for which electronic alert 144 is applicable. In one embodiment, alert generator 142 is configured to include in the electronic alert 144 an indication that the target computer system is compromised in the particular way, for example based on results of the analysis for similarity with known anomaly types. For example, the particular way in which the target computer system is compromised may be indicated in the electronic alert 144 to be (i) incipient failure of a component, (ii) a spychip in a component, or (iii) inclusion of a counterfeit component. Where no anomaly is detected, in one embodiment, alert generator 142 is configured to generate an alternative electronic alert indicating that no anomaly is detected.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of an automated function in response to detection of anomalous behavior 117. In one embodiment, the automated function is configured to cause the target computing system 110 that is exhibiting the anomalous behavior 117 to be automatically taken out of service. In one embodiment, the electronic alert may be presented in a user interface such as a graphical user interface (GUI) by extracting the content of the electronic alert. The GUI may present a message, notice, or other indication that the status of operation of the target computing system 110 that is exhibiting the anomalous behavior 117 has entered (or left) an anomalous state of operation.

In general, components of EMI scanning system 100 intercommunicate by electronic messages or signals. Where the components are configured to perform computing functions or procedures, the electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of EMI scanning system 100 may (i) generate or compose an electronic message or signal to issue a command or request to another component, (ii) transmit the message or signal to other components of EMI scanning system 100, (iii) parse the content of an electronic message or signal received to identify commands or requests that the component can perform, and (iv) in response to identifying the command or request, automatically perform or execute the command or request. The electronic messages or signals may include queries against databases, such as databases that are configured to store and serve time series data. The queries may be composed and executed in query languages compatible with the database and executed in a runtime environment compatible with the query language.

### —Selected Features of Example EMI Monitoring System—

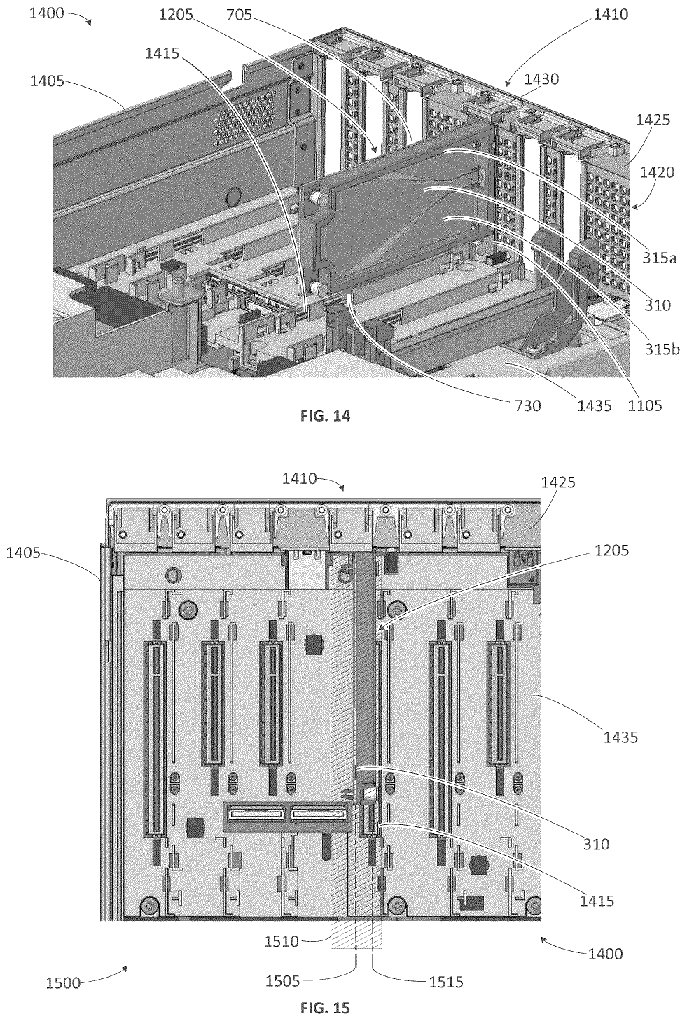

In one embodiment, the broadband antenna card 115 is installed in an expansion slot 120 of the target computer 110, for example as shown and described with reference to FIGS. 14-16.

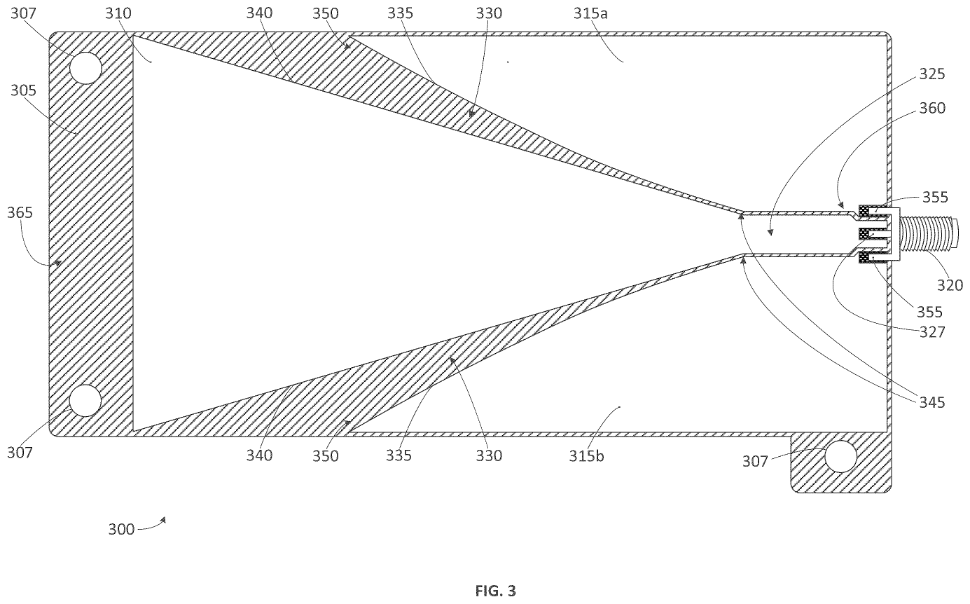

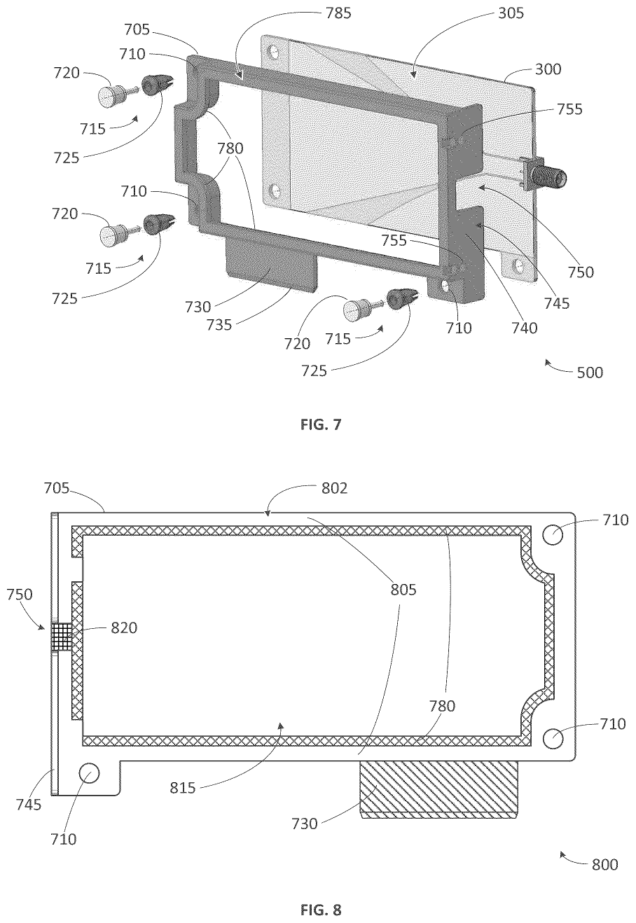

In one embodiment, the broadband antenna card 115 is an assembly of various components, as shown and described with reference to FIGS. 3-13. The components include a nonconductive frame that has a dummy edge finger configured for mechanically engaging an expansion connector of the expansion slot, as shown and described with reference to FIGS. 7-10. The components of broadband antenna card 115 also include a monopole antenna supported by the nonconductive frame in a location that is offset laterally from the dummy edge finger towards a center of the expansion slot, as shown and described with reference to FIGS. 3-13. For example, the monopole antenna is supported by the nonconductive frame near a lateral center of the expansion slot. And, the components of broadband antenna card 115 include a radiofrequency connector 320 that is electrically (and communicably) connected to the monopole antenna and to the radio receiver, for example as shown and described with reference to FIGS. 1 and 3.

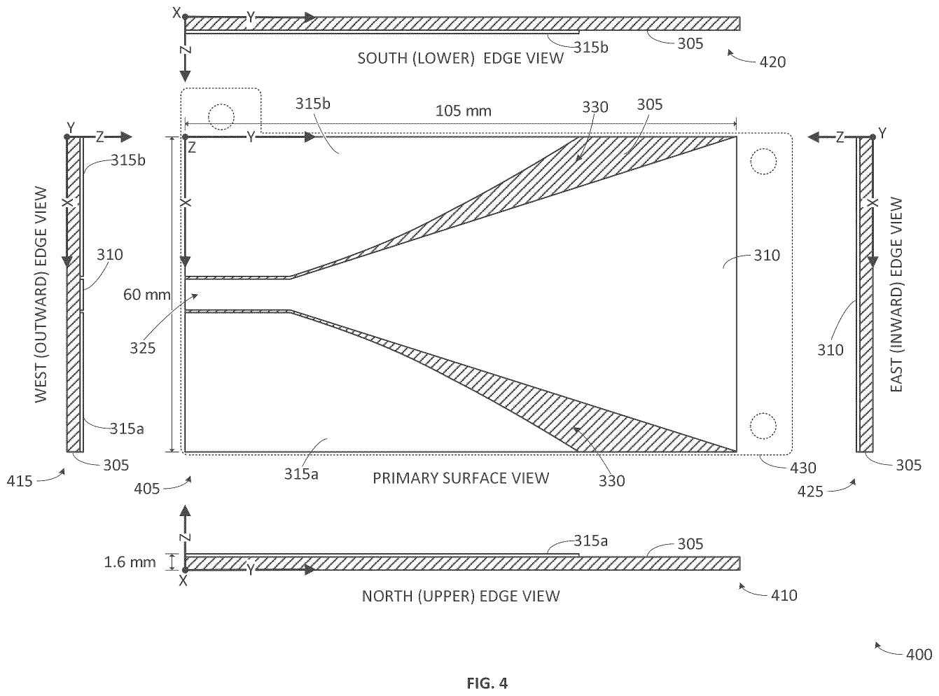

In one embodiment, the monopole antenna is a planar antenna that is configured to gather broadband radiofrequency emissions, for example as shown and described with reference to FIGS. 3 and 4. The monopole antenna includes (i) a dielectric substrate conforming to dimensional specifications of a low-profile PCIe expansion card. The monopole antenna includes (ii) a substantially triangular antenna region printed in conductive material on the dielectric substrate. And, the monopole antenna includes (iii) a pair of ground regions printed in the conductive material on the dielectric substrate on opposing sides of the antenna region. Gaps between the ground regions and the antenna region progressively widen by a spline curvature of edges of the ground regions away from edges of the antenna region.

In one embodiment, EMI monitoring system 100 further includes a management network 134 communicably coupling the EMI scanning computer 105 and the target computer 110. The EMI monitoring system 100 further causes the target computer 110 to initiate execution of the test pattern 113 in response to a test command 132 received through the management network 134. And, EMI monitoring system 100 further causes the EMI scanning computer 105 to initiate the taking of the readings in response to a scan command received through the management network 134, for example from a management system configured to manage a data center that includes the EMI monitoring system 100. In one embodiment, the EMI monitoring system 100 is configured to cause the execution of the test pattern 113 in the target computer system 110 to be automatically initiated by delivering a test command 132 to management logic 160 of the target computer system 110.

In one embodiment, EMI monitoring system 100 includes a plurality of target computers, each equipped with broadband antenna cards 115. Thus, in one embodiment, EMI monitoring system 100 further includes (i) one or more additional target computers 110; and (ii) one or more additional broadband antenna cards 115 installed within the chassis 123 of the additional target computers 110. The radio receiver 125 is electrically connected to the additional broadband antenna cards 115, for example through feedlines 183 and RF switch 165. And, the radio receiver 125 is configured to automatically switch between the broadband antenna cards 115 in response to a switch command, for example using RF switch 165.

In one embodiment, EMI monitoring system 100 is an in-situ installation in a data center, in which, for example, broadband antenna cards 115 installed in a plurality of target computers 110 are connected to radio receiver 125 through a RF switch 165 for scanning. In one embodiment, EMI scanning computer 105, broadband antenna card(s) 115, and radio receiver 125 are configured for installation in a data center. In one embodiment, EMI scanning computer 105, and radio receiver 125 are configured to be portable with reference to target computers 110 installed in a data center, with the broadband antenna cards 115 installed in the target computers 110, and the radio receiver configured to be connected to individual broadband antenna cards 115 in turn.

In one embodiment, EMI monitoring system is configured to take readings by (i) dividing a broadband spectrum of the radiofrequency EMI into a plurality of frequency bins; and (ii) sampling amplitude values from pre-selected frequency bins of the plurality of frequency bins that are selected to be representative of the reference computer system to form the readings of the radiofrequency EMI.

### —Example EMI Scanning Method—

FIG. 2 illustrates one embodiment of an EMI scanning method 200 associated with a specialized fingerprinting antenna for EMI fingerprint characterization of computing systems. EMI scanning method 200 is one example process by which anomalous behavior 117 of compute hardware 150 may be detected using broadband antenna card 115.

In one embodiment, as a general overview, EMI scanning method 200 causes a target computer system to execute a test pattern, and during the test pattern takes readings of EMI emitted by the target computer using a broadband antenna installed as a probe within the chassis of the target computer system. Based on the collected readings, EMI scanning method 200 detects whether the EMI target computer system is compromised (by a counterfeit component, spychip, component degradation) or otherwise anomalous based on dissimilarity between the readings and ML estimates for the readings. EMI scanning method 200 then generates an electronic alert that indicates the results of the detection analysis.

In one embodiment, EMI scanning method 200 initiates at START block 205 in response to a EMI scanning system (such as EMI scanning system 100) determining one or more of (i) a target computer has started up, where EMI scanning method 200 is performed upon startup of the target system; (ii) an instruction or command to perform EMI scanning method 200 has been received (for example through a management network); (iii) a user or administrator of a EMI scanning system has initiated EMI scanning method 200; (iv) it is currently a time at which EMI scanning method 200 is scheduled to be run; or (v) that EMI scanning method 200 should commence in response to occurrence of some other condition. In one embodiment, a computer system configured by computer-executable instructions to execute functions of EMI scanning computer 105 executes EMI scanning method 200. Following initiation at start block 205, EMI scanning method 200 continues to block 210.

At block 210, EMI scanning method 200 causes a target computer system to execute a test pattern of computer operations. In one embodiment, EMI scanning method causes the test pattern to be executed by sending an electronic message to the target computer system that is configured to initiate computer operations in accordance with the test pattern. For example, EMI scanning method 200 generates a test command that is configured to cause the management logic of the target computer system to operate the compute hardware of the target computer system as prescribed by the test pattern. The test command is an electronic instruction, and EMI scanning method 200 transmits the test command to the management logic of the target computer system, for example by way of a management network connection between the EMI scanning computer and the management logic. In one embodiment, the test pattern may be stored locally in management logic, and accessed from memory in response to receiving the test command. In one embodiment, the test pattern may be sent to the management logic in conjunction with the test command, for example as a payload of the test command, or as an additional message accompanying the test command.

In one embodiment, EMI scanning method 200 operates the target computer system in accordance with the test pattern using the management logic. As discussed above with reference to test pattern 113, the test pattern prescribes a pattern of workload through which the target computer system is run. The management logic varies utilization of the compute hardware of the target computer system (e.g., by PWM load profiling) as specified by the test pattern. During the execution of the test pattern, the computer hardware emits RF EMI. At some wavelengths, the emitted RF EMI varies in a manner that is correlated with the test pattern.

Thus, in one embodiment, EMI scanning method 200 causes a target computer system to execute a test pattern of computer operations by generating an electronic message configured to cause management logic of the target computer to execute the test pattern, transmitting the message to the management logic of the target computer system that is being subjected to the EMI scan, and upon receiving the message, loading the test pattern, and operating the computer hardware in accordance with the test pattern. In one embodiment, the activities of block 210 are performed using test manager 130, management logic 160, and compute hardware 150.

At block 215, EMI scanning method 200 takes readings of radiofrequency EMI through a broadband antenna card that is installed within a chassis of the target computer system. The radiofrequency EMI is generated by the target computer system during execution of the test pattern. In one embodiment, EMI scanning method 200 takes readings from a radio receiver of EMI sensed by the broadband antenna card within the chassis of the target computer during execution of the test pattern.

In one embodiment, the compute hardware is executed in the test pattern to induce voltages in an antenna component of the broadband antenna card. The induced voltages are sensed EMI. The sensed EMI is passed out of the broadband antenna card (for example through an RF connector of the antenna card, a feedline, (optionally) an RF switch) to an antenna input of a radio receiver. The radio receiver digitizes the sensed EMI into discrete values for the induced voltages, and sends a stream of the digitized EMI to a readings generator.

In one embodiment, the EMI scanning method 200 generates a target EMI fingerprint of the target computer system. Using the readings generator, the EMI scanning method 200 generates a time series of readings from the stream of digitized EMI values. For example, the EMI scanning method generates a multivariate time series of readings from the sensed EMI. The readings in the multivariate time series may include amplitude values for each of a set of pre-selected frequencies. Accordingly, EMI scanning method partitions the spectrum sensed by the broadband antenna card into contiguous frequency bins that are represented by a frequency within the bin. Then, EMI scanning method 200 converts the stream of digitized EMI values into a PSD for the stream over a moving window. EMI scanning method 200 samples the values for the readings from the PSD in the bins that are represented by the pre-selected frequencies. In one embodiment, the pre-selected frequencies are the frequencies of the sensed EMI that most corresponded to the test pattern (i.e., the salient or information-bearing frequencies) when the test pattern was executed on the reference (e.g., golden sample) computer system.

EMI scanning method 200 takes readings of radiofrequency EMI through a broadband antenna card by accessing a stream of digitized EMI values obtained from the broadband antenna, performing an FFT on incremental portions of the stream, and sampling the amplitudes of the resulting PSD at pre-selected frequencies to generate the readings as observations of a time series. In this manner, EMI scanning method 200 generates a target EMI fingerprint of readings. In one embodiment, the activities of block 215 are performed using readings generator 135, radio receiver 125, and broadband antenna 120.

At block 220, EMI scanning method 200 detects whether hardware of the target computer system is behaving abnormally. In one embodiment, hardware behaves abnormally when it operates in a way that differs substantially from what would be expected for the hardware of a reference system of a same type. The detection is based on a dissimilarity between the readings of radiofrequency EMI and radiofrequency EMI for nominal operation of a reference computer system. In one embodiment, EMI scanning method performs an EMI fingerprint comparison of the readings from the target computer system to reference readings of a reference computer system of a similar hardware configuration to the target computer system. In one embodiment, the reference readings are machine learning estimates of the radiofrequency EMI for nominal operation of a reference computer system generated by a machine learning model from the readings of the target computer system. In one embodiment, the reference readings are readings of the radiofrequency EMI for nominal operation of a reference computer system, for example previously recorded readings of the reference system. The comparison detects anomalous dissimilarity between the readings for the target and reference computer systems using an anomaly detection model.

In one embodiment, where the reference readings are generated by machine learning model from the readings of the target computer system, the machine learning model is a multivariate state estimation model. The machine learning model is trained to generate estimates for each of the pre-selected frequencies that are consistent with nominal operation of a reference computer of a similar or same hardware configuration as the target computing device. EMI scanning method 200 monitors the readings of radiofrequency EMI sensed from the target computing device with the trained machine learning model. The monitoring process generates ML estimates using the trained machine learning model, and then determines the differences or residuals between what the amplitudes of the pre-selected frequencies are expected to be (the ML estimates) and what the amplitudes of the pre-selected frequencies actually are observed to be (the readings). This results in a time series of residuals between the model-estimated values for the EMI, and the observed values for the EMI. For example, the residuals between estimate and reading values for each of the pre-selected frequencies at corresponding time indexes are stored in a time series of residuals at the corresponding time indexes. One or more of the time series of such residuals may be provided to an anomaly detection model to detect when deviations from expected values are anomalous.

In another embodiment, where the reference readings are readings of nominal operation of the reference computer system, EMI scanning method 200 accesses a reference database (such as reference database 146) to retrieve the reference readings of nominal operation (such as nominal readings 148) for computing devices having a similar or same hardware configuration as the target computing device. EMI scanning method temporally aligns the indexes of the target readings and the reference readings, and then determines the differences or residuals between what the amplitudes are expected to be (the reference readings) and what the amplitudes actually are observed to be (the target readings) at the pre-selected frequencies. This results in a time series of residuals between the pre-recorded nominal values and the currently observed values of the EMI. For example, the residuals between nominal and observed values are stored in a time series of residuals at corresponding time indexes to the nominal and observed values. One or more of the time series of such residuals may be provided to an anomaly detection model to detect when deviations from expected values are anomalous.

In one embodiment, the anomaly detection model is configured to determine when the values of target readings and reference readings (estimates or nominal values) differ to an extent that satisfies a threshold condition for detection of an anomaly. In one embodiment, the anomaly detection model is a SPRT analysis of time series of residuals between the target and reference readings. For each pre-selected frequency, dissimilarity between the target and reference readings is quantified by the values of the residuals. Where the dissimilarity between target and reference readings deviates in a statistically significant manner (or is otherwise sufficiently large) for one or more variables, the anomaly detection model enters an alarm state that indicates the presence of anomalous EMI readings. The EMI scanning method 200 thus detects that the target computer system is emitting anomalous EMI. Where the target computer system is emitting anomalous EMI, the target computer system is compromised in some way, for example due to incipient hardware degradation, the presence of a spychip, or the presence of a counterfeit component.

Thus, in one embodiment, EMI scanning method 200 detects whether hardware of the target computer system is behaving abnormally by generating, for a time series of readings, a time series of corresponding estimates of the values for the set of pre-selected frequencies included in the readings, determining a time series of residuals between the estimates and readings for the set of pre-selected frequencies, and analyzing the time series of residuals with a detection model until an anomaly is detected, or a time limit elapses and no anomaly is detected. And, in one embodiment, EMI scanning method 200 detects whether hardware of the target system is behaving abnormally by retrieving a reference time series of readings for the set of pre-selected frequencies from a reference computer system, determining a time series of residuals between the readings for the target computer system and the readings for the reference computer system, and analyzing the time series of residuals with a detection model until an anomaly is detected, or a time limit passes without detection of an anomaly. In one embodiment, the activities of block 220 are performed using EMI dissimilarity detector 140.

At block 225, EMI scanning method 200 generates an electronic alert indicating whether the hardware of the target computer system is behaving anomalously. For example, the electronic alert may indicate that the target computer is emitting anomalous EMI. This “positive” detection electronic alert acts as a warning that the target computer system is compromised, and may need to be removed from service. Or, alternatively, the electronic alert may indicate that the target computer is not emitting anomalous EMI. This “negative” detection electronic alert acts as a certification or confirmation that the target system is uncompromised, and may remain in service.

In one embodiment, the electronic alert is generated by composing and transmitting a computer-readable message including content describing an anomaly status of EMI generated by the target computing system. In one embodiment, EMI scanning method 200 accesses a template alert message from memory or storage. EMI scanning method 200 then populates the content of the alert message.

As described above, where an anomaly is detected, EMI scanning method 200 may populate the template alert message with (i) timestamp(s) at which anomalous EMI was detected, (ii) an indication of the extent by which the values of the readings deviated from the estimates (i.e., by including residuals residuals), (iii) an identification of a frequency bin(s) in which the anomaly was detected, and (iv) an identifier (such as an IP address, a MAC address, or other network address or assigned name) for the particular target computer being scanned (and in which the anomaly was detected).

And, where no anomaly is detected, EMI scanning method 200 may populate the template alert message with (i) an indication of the extent by which the values of the readings conform to the estimates (i.e., by including residuals), and (ii) the identifier for the particular target computer being scanned (and in which no anomaly was detected).

In one embodiment, the electronic alert may be composed and then transmitted for subsequent presentation on a display, or for other action. The electronic alert may be configured to be presented by display in a graphical user interface (GUI). In one embodiment, the electronic alert may be used to cause an automatic adjustment to the usage of the target computing device. For example, the electronic alert may initiate a process to automatically take the target computing device out of service, or to restrict the use of the target computing device to lower-security applications. In one embodiment, the activities of block 225 are performed using alert generator 142.

At the conclusion of block 225, EMI scanning method 200 proceeds to END block 230, where EMI scanning method concludes. In one embodiment, EMI fingerprints taken by an installed broadband antenna card have been used to either detect that a target computer has been compromised, or confirm that the target computer remains uncompromised.

### —Selected Features of Example EMI Scanning Method—

In one embodiment, EMI scanning method 200 further includes installing the broadband antenna card within the chassis in an expansion slot of the target computing device. When installed, a position of the broadband antenna card is mechanically registered on an expansion connector of the expansion slot. Mechanical registration on an expansion connector of the expansion slot reduces variation in the readings of radiofrequency EMI due to shock, vibration, or reinstallation of the broadband antenna card.

In one embodiment, EMI scanning method 200 further includes installing the broadband antenna card within the chassis in a hard disk drive bay. When installed, a position of the broadband antenna card is mechanically registered on one or more physical features of the disk drive slot. Again, mechanical registration on physical features of the disk drive slot reduces variation in the readings of radiofrequency EMI due to shock, vibration, or reinstallation of the broadband antenna card.

In one embodiment, EMI scanning method 200 further includes removing the broadband antenna card from the chassis of the target computer system after generating the electronic alert.

In one embodiment, EMI scanning method 200 further includes, in response to the electronic alert, automatically taking the target computer system out of service.

In one embodiment, EMI scanning method 200 further includes automatically initiating the execution of the test pattern in the target computer system and EMI scanning of the target computer on a repeated schedule.

In one embodiment, EMI scanning method 200 further includes automatically initiating the execution of the test pattern in the target computer system by delivering a test command to management logic of the target computer system.

In one embodiment, EMI scanning method 200 further includes assembling the broadband antenna card to cause the broadband antenna card to have particular components, as discussed in detail below with reference to FIGS. 3-13. For example, the broadband antenna card is assembled to include (i) a nonconductive frame that has a dummy edge finger configured for mechanically engaging an expansion connector of the expansion slot. The broadband antenna card is assembled to include (ii) a planar antenna printed in conductive material on a dielectric substrate. The planar antenna is supported by the nonconductive frame in a location that is offset laterally from the dummy edge finger towards a center of the expansion slot. This provides for additional clear space from additional expansion cards in adjacent expansion slots. And, the broadband antenna card is assembled to include (iii) a radiofrequency connector electrically connected to the planar antenna and to the EMI scanning system.

In one embodiment, taking readings of the radiofrequency EMI (as described at block 215) further includes steps to effect a time-domain to frequency-domain to time-domain double transformation to generate an EMI fingerprint. In particular, taking readings further includes dividing a broadband spectrum of the radiofrequency EMI into a plurality of frequency bins. And, taking readings further includes sampling amplitude values from pre-selected frequency bins of the plurality of frequency bins that are selected to be representative of the reference computer system to form the readings of the radiofrequency EMI. The readings are formatted as a multivariate time series of the amplitude values from the pre-selected frequency bins.

In one embodiment, EMI scanning method 200 further includes a step of detecting that the target computer system is compromised in a particular way. The particular way in which the target computer system is compromised is one of (i) incipient failure of a component, (ii) a spychip in a component, or (iii) inclusion of a counterfeit component. And, EMI scanning method 200 further includes a step of including in the electronic alert an indication that the target computer system is compromised in the particular way.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) or method steps as described herein.

### —Example PCB Fingerprinting Antenna—

FIG. 3 illustrates one embodiment of a printed circuit board (PCB) 300 for a specialized fingerprinting antenna associated with EMI fingerprint characterization of computing systems. In one embodiment, PCB 300 includes a substrate 305, an antenna region 310, ground region(s) 315, and a connector such as a radiofrequency (RF) connector 320. In one embodiment, PCB 300 is a planar monopole antenna that is configured to gather broadband radiofrequency emissions, for example from within an interior of a chassis of a computer system.

Substrate 305 conforms to dimensional specifications of an expansion card for a computer system. In other words, substrate 305 has external dimensions (of length, height, and thickness) that do not exceed a dimensional envelope allotted to an expansion card, such as a card electromechanical volume (CEM). In one embodiment, the dimensions of substrate 305 further has external dimensions that do not cumulatively exceed the allotted envelope when combined with a support frame (as described in further detail herein below, for example, support frame 705). The particular dimensional specifications of substrate 305 depend on a type of expansion card, as discussed in further detail below. For example, in one embodiment, the substrate 305 has dimensions that fall within the dimensional envelope allotted for a low-profile peripheral component interconnect express (PCIe) expansion card. For example, from north edge to south edge (including edge fingers), the substrate 305 and support frame are within 68.9 mm. From west edge to east edge, the substrate 305 and support frame are within 167.65 mm for a half-length PCIe card, 254.00 mm for a three-quarter length PCIe card, and 312.00 mm for a full length PCIe card. In this way, the substrate 305 conforms to dimensional specifications of a low-profile PCIe expansion card.

In one embodiment, substrate 305 includes one or more mounting holes 307 for connecting PCB 300 to a frame. In one embodiment, there are three mounting holes 307. The three mounting holes 307 are placed outside of the antenna structure (antenna region 310 and ground regions 315). The three mounting holes are cut through corners of PCB 300. For example, the mounting holes 307 are in northeast, southeast, and southwest corners of PCB 300. The holes accept connections to a support frame (such as support frame 705). The support frame gives a stiff structure for retaining PCB 300. In one embodiment, outside corners of PCB 300 are slightly rounded, for example with a radius between 1 and 1.5 mm, such as 1.25 mm.

Substrate 305 is an electrically insulating (that is, dielectric) substrate. In one embodiment, substrate 305 is glass-reinforced epoxy laminate material that is flame resistant, such as FR-4. In general, a substrate having a dielectric constant (E) below 5 is acceptable. FR-4, for example, has a dielectric constant (E) between 3.9 and 4.7, for example, 4.5 (at 1 GHZ). In one embodiment, the substrate may be polyimide material, which has dielectric constant (e) between 3.3 and 3.8. In one embodiment, the substrate may be polytetrafluoroethylene (PTFE) material, which has a dielectric constant between 2.0 and 2.1. The low dielectric constant reduces interference by the substrate 305 with antenna response on a secondary side of the substrate for an antenna printed on a primary face of the substrate.

Antenna region 310 is a region of conductive trace disposed on substrate 305. Antenna region 310 is substantially triangular. An antenna region is substantially triangular where it widens from a narrow end to a wide end. Substantial triangularity can be indicated by overlap of edges of the antenna region with a triangle. For example, antenna region 310 is substantially triangular because at least three edges of antenna region 310 are congruent with edges of a triangle. Or, where edges of an antenna region are not linear, substantial triangularity can be indicated where at least three edges of antenna region 310 approximately follow edges of a triangle. In one embodiment, antenna region 310 includes a throat 325. Throat 325 is a region of conductive trace disposed on substrate 305. Throat 325 is at a narrow end of antenna region 310. Throat 325 is a part of antenna region 310. For example, throat 325 overlaps and merges with a westmost point of a triangle defined by outer edges of antenna region 310. A signal contact 327 of RF connector 320 is electrically (conductively) connected to antenna region 310 at throat 325. This connection of signal contact 327 may also be referred to as a feed point of the antenna. The feed point connection of signal contact 327 may be, for example, at a westmost end of throat 325 opposite to where throat 325 merges into the triangle of antenna region 310.

Ground regions 315 are regions of conductive trace disposed on substrate 305. In one embodiment there are a plurality of ground regions 315. For example, PCB 300 may include a pair of ground regions 315, including north (or upper) ground region 315a and south (or lower) ground region 315b. Ground regions 315 flank antenna region 310 on opposite sides of antenna region 310. For example, north ground region 315a is disposed on substrate 305 above a first, upper side of antenna region 310, and south ground region 315b is disposed on substrate 305 below a second, lower side of antenna region 310. In one embodiment, there is one ground region, for example disposed on one side or another of antenna region 310.

There are gaps 330 in the conductive trace material between ground regions 315 and antenna region 310. North ground region 315a and south ground region 315b are separated from each other by antenna region 310, and by gaps 330 around antenna region 310. Gaps 330 progressively widen from west to east along PCB 300. In other words, gaps 330 progressively taper from east to west along PCB 300.

In one embodiment, gaps 330 progressively widen by a curvature of inner edges 335 of ground regions 315 away from straight outer edges 340 of the triangular antenna region 310. For example, the curvature of inner edges 335 may be a spline curve. In one embodiment, at a westmost, narrowest taper 345 of the gaps 330, the spline curves are approximately parallel with the outer edges 340 of the triangular antenna region 310. At an eastmost, widest taper 350 of the gaps 330 where the inner edges 335 of ground regions 315 terminate near the edge of substrate 305, the spline curves are at an acute angle of approximately 10 to 20 degrees (for example, 16 degrees) from parallel with the outer edges 340 of the triangular antenna region 310. In one embodiment, the spline curves are three-point piecewise cubic splines with natural end conditions. Thus, in one embodiment, the spline curve is defined by a plurality of cubic function segments, each interpolated through three points. Because the cubic function segments have “natural” or “free” end conditions—meaning that the cubic function “flattens out” at endpoints and has a first derivative of zero—the cubic function segments transition smoothly into adjacent segments without abrupt changes in slope. Curves other than splines may also be used, such as exponential curves, arcs (circular sections), and other curves that move away from a line that is parallel to the curve at an initial point.

The conductive trace is a sheet, layer, lead, or path of electrically transmissive material. The conductive trace material is laminated onto or otherwise affixed to the surface of the substrate 305, forming antenna region 310 and ground regions 315. In one embodiment, the conductive trace material is copper foil. Other conductive materials, including aluminum, silver, gold, and various alloys of copper can also be appropriate for forming the conductive trace of antenna region 310 and ground regions 315.

In one embodiment, the antenna region 310 of conductive trace and ground regions 315 of conductive trace are coated with a corrosion-resistant conductive coating, which may also be referred to herein as an oxidation-resistant conductive coating. The corrosion-resistant conductive coating prevents corrosion and/or oxidation from changing the electrical properties of the antenna with regard to radiofrequency reception. In one embodiment, the conductive trace is plated with gold or palladium. Thus, in one embodiment, the antenna region 310 and ground regions 315 are formed of gold (or palladium)-coated copper. In one embodiment, the traces are coated with gold, for example using the ENIG (Electroless Nickel Immersion Gold) process. In one embodiment, the traces are coated with palladium, for example using the ENEPIG (Electroless Nickel Electroless Palladium Immersion Gold) or ENEPEG (Electroless Nickel Electroless Palladium Electroless Gold) processes. Other conductive, oxidation/corrosion resistant materials may also be used as an oxidation and corrosion resistant layer on the conductive trace, including nickel, tin, and silver, although these other materials may have less resistance to oxidation over time in the absence of a conformal coating.

In one embodiment, the printed circuit board 300 is uncoated by non-conductive materials. That is, the conductive antenna region 310 and ground regions 315 lack a conformal coating on their exterior surfaces. Conformal coatings are generally a layer of polymer film, lacquer, or other non-conductive film covering the conductive trace and/or substrate. Conformal coatings provide some resistance to oxidation and corrosion of the and the consequent change in electrical properties of the antenna. In general, oxidation and corrosion-resistant metal (e.g., gold) plating of the conductive layers provides superior resistance to change in the electrical properties of the antenna in comparison with conformal coating. The radiofrequency characteristics of some conformal coatings can change over time due to aging, environmental exposure, temperature cycling, moisture, vibration, or other degradation factors. And, the radiofrequency characteristics of some conformal coatings may be inconsistent due to variations in curing, uneven application, or contamination. In one embodiment, conformal coating may be applied to printed circuit board 300 over the conductive trace and/or substrate. In one embodiment, where conformal coating is applied, the conformal coating is selected from among those that are considered transparent to RF signals, such as acrylic coatings, parylene coatings, and some silicone or urethane coatings.

In one embodiment, the oxidation and corrosion-resistant layer is chosen so as to cause the antenna to retain its electrical/radiofrequency characteristics indefinitely. This helps ensure accuracy and consistency in EMI scan readings. In one embodiment, the antenna is constructed to last for at least the design lifetime of a target computer in which it is installed, for example, 5 to 10 years, or even 20 years.

In one embodiment, an additional area 365 of substrate 305 at the east end of PCB 300 is reserved for silkscreen and part number stickers. Additional area 365 is not coated with conductive trace material. In one embodiment, additional area 365 is coated with solder mask. Lack of conductive trace material and presence of solder mask in additional area 365 prevents unintentional influence of conductive material on the electrical characteristics of the antenna.

Referring briefly to FIG. 4, FIG. 4 illustrates multiple views of an example PCB 400 for a specialized fingerprinting antenna associated with EMI fingerprint characterization of computing systems. The views include a view of primary surface 405, a view of north (upper) edge 410, a view of west (outward) edge 415, a view of south (lower) edge 420, and a view of east (inward) edge 425. The view of primary surface 405 shows circuit trace (including antenna region 310 and ground regions 315) disposed on substrate 305. In one embodiment, a secondary surface (not shown) is blank and free of circuit trace. Substrate 305 may extend beyond the area occupied by trace to an outer boundary 430. Outer boundary 430 conforms to dimensional specifications of an expansion card.

Example PCB 400 conforms to dimensional specifications of a low-profile PCIe expansion card. The height of the region occupied by trace in example PCB 400 is 60 mm (or less): in one embodiment, the vertical height of the antenna region 310 at its tallest (and from upper and lower edges of ground regions 315) is 56 mm. This leaves a 2 mm border (or “keep-out” area) of substrate between the region of conductive trace and outer boundary 430, in accordance with the CEM allowed for a low-profile PCIe. And, the width of the region occupied by trace in example PCB 400 is 105 mm (or less). The area of trace in example PCB 400 thus remains within an area allotted to components and trace for a low-profile PCIe expansion card. In one embodiment, the overall thickness of PCB 400 is 1.6 mm, as is shown (with exaggerated thickness) in edge views 410, 415, 420, and 425. The overall thickness of PCB and trace thus remains well within a thickness available for PCB, trace, and components for a low-profile PCIe slot.

Referring again to FIG. 3, the connector is communicably coupled to the antenna region. In one embodiment, radiofrequency connector 320 includes signal contact 327 and ground contact 355. Antenna region 310 is electrically connected to signal contact 327. Ground regions 315 are electrically connected to the ground contact 355. Through ground contact 355, ground regions 315 are electrically grounded or earthed, for example by connection to an electrically conductive computer chassis that is itself grounded electrically. In one embodiment, north ground region 315a is electrically connected to south ground region 315b through ground contact 355.

In one embodiment, radiofrequency connector 320 is configured to create a separable connection between antenna region 310 and a feedline to a radio receiver. (In an alternative embodiment discussed below under the heading “Alternative On-Board Receiver Configuration”, the radio receiver is on-board PCB 300, and the connector is configured to create a separable connection between the on-board radio receiver and a data network.) In one embodiment, radiofrequency connector 320 is a coaxial connector. In a coaxial connector, signal contact 327 is connected to a signal lead which extends through a center of the connector, and ground contact 355 are connected to an outer interface (such as a threaded barrel) that surrounds and is electrically insulated from the signal lead. In one embodiment, the conductive portions of radiofrequency connector 320 are plated with gold or other oxidation and corrosion-resistant metal to preserve the electrical characteristics of radiofrequency connector 320.

In one embodiment, radiofrequency connector 320 is a SubMiniature version A connector—a type of semi-precision coaxial radiofrequency connector having a screw-type coupling mechanism. In one embodiment, radiofrequency connector 320 is a female connector. In one embodiment, radiofrequency connector 320 is a male connector. In one embodiment, radiofrequency connector 320 is a straight edge mount connector that is configured to straddle an edge of PCB 300, for example having one or more ground contacts 355 extending over both primary and secondary surfaces of PCB 300.

In one embodiment, the throat 325 of antenna region 310 is narrowed slightly to allow for soldering to surface mount connectors of radiofrequency connector 320. In one embodiment, the shapes of antenna region 310 and ground regions 315 may be adjusted to align soldering pads with signal contact 327 and ground contacts 355 of RF connector 320. For example, throat 325 of antenna region 310 may be waisted inward towards a center axis of antenna region 310, and tabs of the ground regions 315 extended inward towards the center axis, as shown at reference 360.

Other connector types may also be acceptable for use as radiofrequency connector 320. For example, suitable RF connectors may include a wide variety of coaxial connectors such as Reverse-Polarity SMA, SMB (SubMiniature version B), SMC (SubMiniature version C), Type N, F-type, RCA (Radio Corporation of America), QLS (Quick Lock Standard), QMA (Quick-Lock SMA) and QN (Quick-Lock N), BNC (Bayonet Neill-Concelman), TNC (Threaded Neill-Concelman), C-type (Concelman), DIN 1.0/2.3, DIN 4.3/10, UHF and mini-UHF, Motorola, Belling-Lee, FME (For Mobile Equipment), LEMO (or other push-pull connectors), MCX (Micro Coaxial), and MMCX (Micro-Miniature Coaxial) connectors. Suitable RF connectors may also include multi-pin connectors such as USB (universal serial bus), RJ-45, HDMI, Firewire, and a wide variety of other connectors capable of establishing an electrical connection to an electrical cable for carrying information about the EMI detected by antenna region 310.

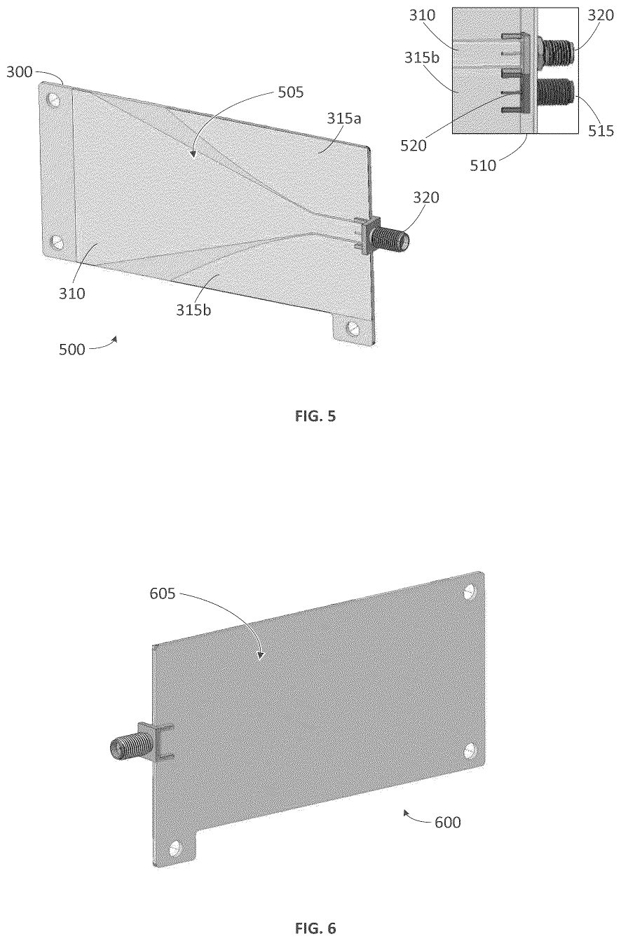

FIG. 5 illustrates a three-dimensional (3D) view 500 of PCB 300 showing a primary surface 505 of PCB 300 for a specialized fingerprinting antenna associated with EMI fingerprint characterization of computing systems. Primary surface 505 has the antenna region 310 and ground regions 315 disposed thereon, for example as shown in FIGS. 3 and 4. RF connector 320 is edge mounted such that the ground contacts connect the ground regions 315 around the antenna region 310.

In one embodiment, as shown in inset view 510, PCB 300 may include an additional radiofrequency connector 515 in addition to radiofrequency connector 320. Additional radiofrequency connector 515 provides an electrical connection for shielded output of the ground regions 315a, 315b, and chassis of a target computer via additional signal contact 520.

FIG. 6 illustrates a 5D view 600 of PCB 300 showing a secondary surface 605 of PCB 300 for a specialized fingerprinting antenna associated with EMI fingerprint characterization of computing systems. Secondary surface 605 is on the reverse of PCB 300 from primary surface 505. In one embodiment, secondary surface is left blank, and has no antenna, ground, or other conductive trace disposed thereon.

### —Selected Features of Example PCB Fingerprinting Antenna—

In one embodiment, PCB 300 is configured to be installed in an expansion slot of the computer system with the antenna region 310 and ground regions 315 oriented within an interior of a chassis of the computer system and the radio-frequency connector 320 extending to an exterior of the chassis of the computer system.

In one embodiment, PCB 300 is further assembled as a fingerprinting antenna expansion card, as described in detail below. In this assembly, PCB 300 further includes a nonconductive frame affixed to substrate 305 and an I/O bracket attached to the nonconductive frame. The nonconductive frame has a dummy edge finger that is configured to mechanically engage with an expansion connector of the computer system. The nonconductive frame includes a seating surface configured to offset the substrate 305 towards a center of a volume allotted to an expansion slot of the computer system. Radiofrequency connector 320 extends through an opening in the I/O bracket.

In one embodiment, gaps 330 progressively widen by a spline curvature of inner edges 335 of the ground regions away from outer edges 340 of the triangular antenna region 310.

In one embodiment, the antenna region 310 further comprises a throat 325 of conductive trace disposed on the substrate 305 at a narrow end of the antenna region 310. Signal contact 327 is electrically connected to the antenna region 310 at the throat 325.

In one embodiment, the connector is a radiofrequency connector 320 including at least a signal contact 327 and a ground contact 355. The antenna region 310 is electrically connected to the signal contact 327 and the ground regions 315 are electrically connected to the ground contact 355. In one embodiment, radiofrequency connector 320 is a SubMiniature version A female connector.

In one embodiment, PCB 300 is a planar monopole antenna that is configured to gather broadband radiofrequency emissions from within an interior of a chassis of a computer system.

In one embodiment, the antenna region 310 of conductive trace and the ground regions 315 of conductive trace are plated with gold or palladium.

In one embodiment, the substrate 305 has a dielectric constant of less than 5.

In one embodiment, PCB 300 is uncoated by conformal coating.

### —Alternative On-Board Receiver Configuration—

In alternative embodiment, PCB 300 further includes an on-board radio receiver and an on-board data interface. In one embodiment, the on-board radio receiver and an on-board data interface are positioned at a western end of PCB 300, beyond a western edge of the antenna region 310 and ground regions 315a, 315b. Circuit traces of on-board radio receiver and on-board data interface are printed on PCB 300. In one embodiment, on-board radio receiver includes an integrated circuit software-defined radio receiver. On-board radio receiver includes an antenna terminal and an output data bus interface. In one embodiment, on-board data interface includes an integrated circuit data interface. On-board data interface includes an input data bus interface and output port (such as an ethernet or USB port). Circuit traces include a trace connecting throat 325 of antenna region 310 to the antenna terminal of the on-board radio receiver, data bus traces connecting output data bus interface of radio receiver to input data bus interface of data interface, and output port traces connecting output port to an output connector or jack.

In one embodiment, EMI signals captured by antenna 310 are configured to be fed into an antenna terminal of on-board radio receiver. On-board radio receiver is configured to accept EMI signals captured by antenna 310 for processing. On-board radio receiver is configured to generate a series of digital amplitude readings (separated by a sampling interval) of the analog EMI signals sensed by antenna 310; and to transmit the digital amplitude readings through the data bus to the on-board data interface. The on-board data interface is configured to format the amplitude readings to a data structure suitable for transmission over a chosen communication protocol, such as JSON, XML, or binary; to divide the amplitude readings into packets or frames for transmission; and to transmit the packets through the output port to the output connector. From the output connector, a wired or wireless data connection transfers the amplitude readings to another computer that is configured to perform EMI scanning analyses of the amplitude readings, such as computer 2005 described with reference to FIG. 20 below.

In one embodiment, the on-board data interface is a network adapter, such as a wired or wireless ethernet adapter. In one embodiment, the on-board data interface is a universal serial bus (USB) interface. In the “on-board” configuration, radiofrequency connector 320 is replaced by a data connector, such as an ethernet jack, USB port, or a wireless ethernet antenna (although, in one embodiment, the wireless ethernet antenna itself may be connected to the data interface by a radiofrequency connector). In one embodiment, where the data interface is a USB interface, a USB wired or wireless ethernet dongle may be attached to provide the data connection through an ethernet network. Additional detail regarding the on-board radio receiver is described below with reference to radio receiver 2001 of FIG. 20. Thus, in one embodiment, the connector may be communicably coupled (that is, electrically connected) to the planar antenna either directly through signal lead (as discussed in depth above), or in one embodiment through additional processing circuits of the on-board radio receiver and on-board data interface. In either case, the connector is accessible from an exterior surface of an antenna expansion card assembly.

In one embodiment, the radio receiver and data interface may draw power from outside of target computer system 1400, for example through an outward-facing power supply port on west edge of PCB 300. In one embodiment, the radio receiver and data interface may draw power from outside of target computer system 1400, for example from power pins of an expansion connector or from a power connector on the motherboard.

Note, where the radio receiver and/or data interface are included on PCB 300, the operations of these on-board components may introduce their own EMI into the sensed environment. The introduced EMI may undesirably obscure EMI readings from sources associated with the target computer system, potentially somewhat reducing EMI fingerprint accuracy. The introduced EMI may be reduced by shielding the on-board components. While the inclusion of radio receiver and/or data interface on PCB 300 may be acceptable, in general, better performance may be obtained where the radio receiver (and associated data interface) are remote from the PCB 300, and connected to antenna 310 through radiofrequency connector 320.

### —Example Fingerprinting Antenna Expansion Card—

In one embodiment, the fingerprinting antenna of PCB 300 is incorporated into an expansion card assembly for installation into an expansion slot of a target computing system. The expansion card includes a nonconductive frame, a planar antenna supported by the nonconductive frame, an I/O bracket affixed to the nonconductive frame, and a radiofrequency connector to the antenna that is accessible from an exterior surface of the I/O bracket. As discussed above, the planar antenna is printed in conductive material on a dielectric substrate, and is electrically connected to the radiofrequency connector.

FIG. 7 illustrates an exploded 3D view 700 of PCB 300 and an example frame 705 for attachment to PCB 300 that are associated with a specialized fingerprinting antenna for EMI fingerprint characterization of computing systems. Frame 705 is made of nonconductive material to form a nonconductive frame. Frame 705 is affixed to PCB 300. Frame 705 gives a stiff structure to an expansion card form of the EMI fingerprinting antenna. Frame 705 also allows precise and repeatable location of the antenna within an expansion slot volume, for example by mechanically registering an expansion connector of the expansion slot. Frame 705 provides structural rigidity and reduces displacement of the antenna within a target computer system due to shock or vibration during system shipment or operation.

Like PCB 300, the frame 705 (and therefore, the expansion card assembly) has a form factor that conforms to dimensional specifications of an expansion card, and remains within a volume allotted to the expansion card. For example, The expansion card may have a form factor confirming to dimensional specifications of a low-profile PCIe expansion card.

In one embodiment, frame 705 is attached to primary surface 505 of PCB 300 (as shown). In one embodiment, non-conductive frame 705 is attached to secondary surface 605 of PCB 300 (not shown). Frame 705 has holes 710 that align with holes 307. For example, holes 710 are congruent with holes 307 so as to coincide when nonconductive frame 705 when frame 705 is superimposed on PCB 300. Thus, there are pairs of holes that align with each other-one hole 710 in frame 705 and one hole 370 in PCB 300—in corresponding corners of the frame 705 and PCB.

In one embodiment, push-pin rivets 715 are provided for mechanically joining frame 705 and PCB 300 together. Push-pin rivets 715 are installed though the aligned pairs of holes to affix the PCB 300 (in other words, the planar antenna) to the nonconductive frame 705. Push-pin rivets 715 include two parts, a pin 720 and an expanding sheath 725. To secure frame 705 to PCB 300, frame 705 is placed against PCB100 with corresponding holes aligned. Expanding sheath 725 is inserted through hole 710 in frame 705 and corresponding aligned hole 370 in PCB 300, and pin 720 is inserted into expanding sheath 725. Insertion of pin 720 into expanding sheath 725 forces expanding sheath 725 outward to engage with holes 710 and 370, forming a friction fit between rivet 715 and the surrounding holes 710 and 370.

In one embodiment, bolts placed through holes 710 and 370 and nuts placed to compress frame 705 to PCB 300 may be used to join frame 705 to PCB 300. In one embodiment, screws that compress frame 705 to PCB 300 may be used to join frame 705 to PCB 300. In one embodiment, PCB 300 may be snap fit to frame 705, for example using retention hooks extending from the frame 705 to engage with edges of PCB 300. In one embodiment, frame 705 and PCB 300 may be bonded together using an adhesive. A wide variety of other means may also be suitable for join frame 705 to PCB 300.

Nonconductive frame 705 (and push-pin rivets 715) may be made of plastic. For example, polycarbonate (PC) and poly-methyl methacrylate (PMMA or acrylic) may each be suitable plastics for frame 705 due to their relatively high transparency to radiofrequency emissions. Polyethylene terephthalate (PET) may also be used for frame 705, although it has only moderate transparency to radiofrequency emissions. Other structural plastics such as acrylonitrile butadiene styrene (ABS), polyamide (nylon), and polypropylene (PP) may also be used for frame 705, but exhibit low or no transparency to radiofrequency emissions that may limit the response or sensitivity of an EMI fingerprinting antenna. Nonconductive frame 705 may alternatively be made of glass-reinforced epoxy (fiberglass) material (such as FR-4).

Frame 705 includes an edge finger 730 extending along a south outer face of frame 705. In one embodiment, edge finger 730 is an outward tab or protrusion extending along a bottom or south wall of frame 705. Edge finger 730 extends southwards away from the south outer edge of frame 705. Edge finger 730 is configured for mechanically engaging with an expansion connector of an expansion slot. For example, edge finger 730 is physically configured to insert into or mate with the expansion connector in a manner similar to an expansion card, thereby retaining frame 705 in position using the expansion connector. The engagement of edge finger 730 with the expansion connector restrains frame 705 from being displaced to laterally to either side of a long axis of the expansion slot. Edge finger 730 is therefore configured to register the location of frame 705 off of an expansion slot. In one embodiment, edge finger 730 is nonconductive, bearing no edge finger pads or other conductive trace. Edge finger 730 may therefore be considered a “dummy” edge finger, as it is not configured for electrically engaging with the expansion connector of the expansion slot.

In one embodiment, dummy edge finger 730 conforms to the dimensional specifications of an edge finger for an expansion card. For example, edge finger 730 may have a thickness of 1.57 mm, consistent with a thickness of an edge finger for a PCB expansion card. And, edge finger 730 may have a height (extending outward from the outer face of frame 705 along the north-south axis) of 13.69 mm, consistent with a height of an edge finger of a PCB expansion card. In one embodiment, dummy edge finger 730 is configured to fit snugly into at least a portion of an expansion connector. In one embodiment, edge finger 730 may have a chamfer 735 along its southern edge (such as a chamfer of 20 degrees) to aid in insertion of edge finger 730 into an expansion connector. In one embodiment, edge finger 730 may have key cutouts or notches in the southern edge to accommodate the positions of key protrusions in the expansion connector. In one embodiment, where the expansion connector or motherboard is equipped with a retention mechanism, edge finger 730 may have cutouts (for example, along an eastern edge of edge finger 730) configured for engaging with the retention mechanism.

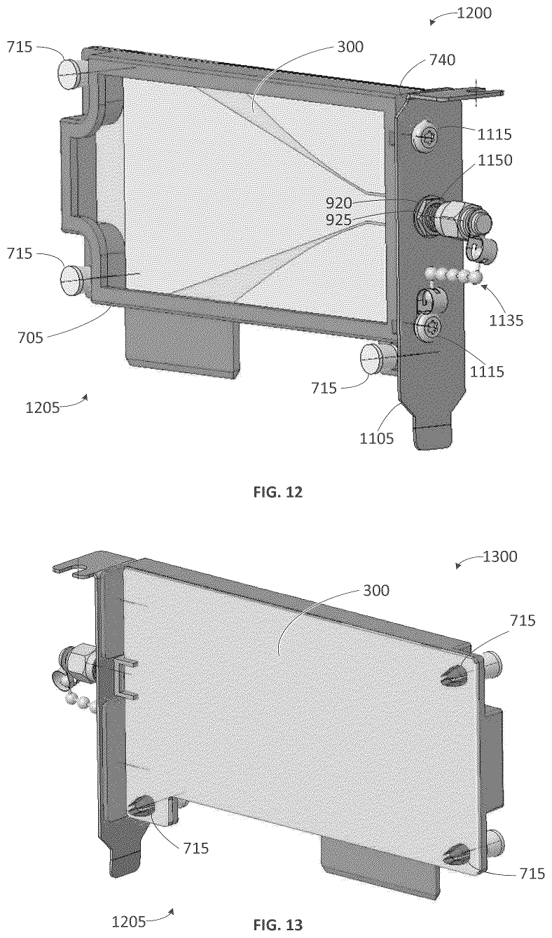

In one embodiment, frame 705 includes a vertical attachment surface 740. Attachment surface 740 is on an exterior of a west wall 745 of frame 705. Attachment surface 740 is substantially planar. West wall 745 of frame 705 includes a notch 750 (or hole) to accommodate passage of an outer profile of radiofrequency connector 320 through west wall 745 of frame 705. Attachment surface 740 is configured to abut an inward face of a vertical wall of an I/O bracket (for example as shown with reference to I/O bracket 1105 in FIGS. 11 and 12). West wall 745 includes pilot holes 755 for accepting screws to attach frame 705 to the I/O bracket. West wall 745 (and other walls of frame 705) are terminated at a primary (front) side 765 of frame 705 by a stiffening flange 760. Stiffening flange 760 extends inward from the perimeter around an opening in the frame.

FIG. 8 illustrates a top view 800 of a secondary (reverse) side 802 of frame 705 which is associated with a specialized fingerprinting antenna for EMI fingerprint characterization of computing systems. The reverse side 802 of frame 705 is configured to face toward and support PCB 300 when attached. Frame 705 includes a seating surface 805. In one embodiment, frame 705 is configured to receive PCB 300 with primary surface 505 of PCB 300 oriented to face the seating surface 805. Seating surface 805 is flat, that is, substantially planar. Seating surface 805 is configured to abut PCB 300 at outside edges of PCB 300. For example, an outer border area (or perimeter area) of primary surface 505 of PCB 300 may rest upon seating surface 805. In one embodiment, an outline of seating surface 805 is substantially congruent with an outline of substrate 305 of PCB 300.

Stiffening flange 760 is set back laterally from the plane of seating surface 805. In one embodiment, stiffening flange 760 is substantially parallel to seating surface 805. The walls of frame 705 extend between seating surface 805 and stiffening flange 760, connecting stiffening flange 760 to seating surface 805. In one embodiment, stiffening flange 760 extends inward into an opening 815 of the frame. Opening 815 reduces the area of frame 705 that may block radiofrequency emissions. In one embodiment, stiffening flange 760 extends fully across opening 815 to close frame 705.

In one embodiment, west wall 745 extends outward laterally above seating surface 805. Notch 750 interrupts seating surface 805 with a recess 820 laterally below the plane of seating surface 805. Recess 820 accommodates an outer profile of radiofrequency connector 320, for example where radiofrequency connector 320 is edge mounted on substrate 305 of PCB 300 and extends above and below substrate 305.

Seating surface 805 is offset laterally from a plane of dummy edge finger 730 towards a center of a volume allocated for an expansion card. The plane of seating surface 805 is substantially parallel to the plane of dummy edge finger 730. In one embodiment, seating surface 805 is offset from the dummy edge finger 730 so as to support the conductive trace of the antenna region 310 and ground regions 315 at a center of the volume allocated for the expansion card. In one embodiment, the planes of seating surface 805, dummy edge finger 730, recess 820, and stiffening flange 760 occupy substantially parallel planes that are offset laterally from each other along a substantially perpendicular axis.

FIG. 9 illustrates an east edge view 900 of frame 705 which is associated with a specialized fingerprinting antenna for EMI fingerprint characterization of computing systems. Frame 705 is a single-width frame for installation in a single expansion slot. A first plane 910 of seating surface 805 is offset laterally from a second plane 915 of dummy edge finger 730 to a center of a volume allocated for one expansion card. In one embodiment, front side 765 may also be offset laterally from dummy edge finger 730 in an opposite direction away from a center of the volume allocated for one expansion card. When seated on seating surface 805 of frame 705, the planar antenna printed on PCB 300 is supported at a lateral middle of the CEM for a single expansion slot. When the PCB 300 and frame 705 assembly is installed in an expansion slot, the frame 705 uses dummy edge finger 730 to register the lateral position of the PCB 300 antenna off of the expansion connector of the expansion slot. In short, the long edge finger 730 at the bottom of the plastic frame 705 locates the card into the expansion (e.g., PCIe) slot connector, while keeping the antenna centered in the PCIe card volume.

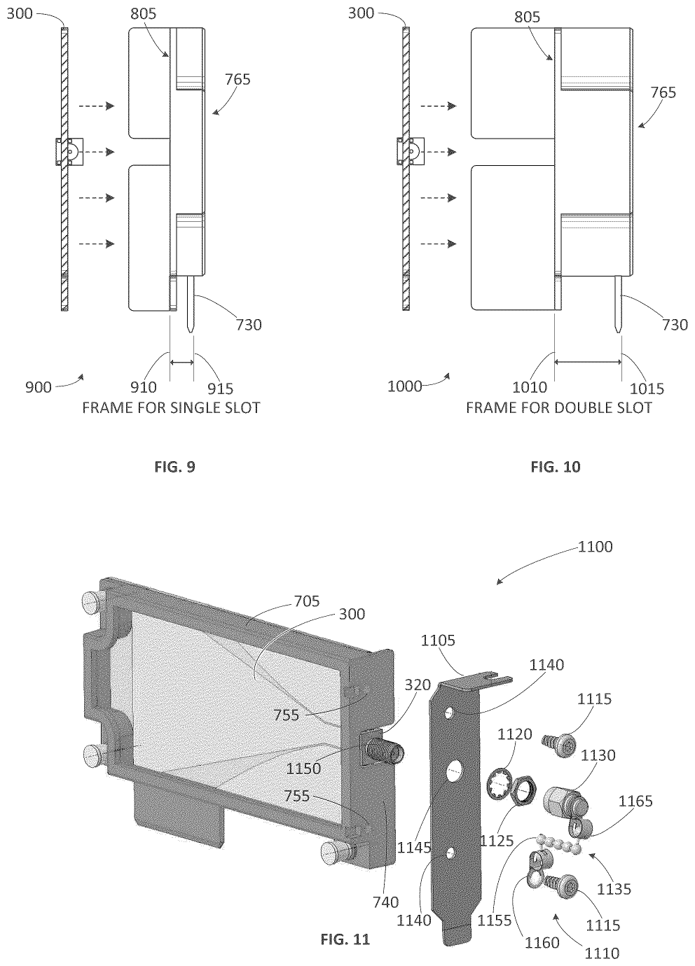

FIG. 10 illustrates an east edge view 1000 of a double-width frame 1005 for installation in a double expansion slot (two adjacent expansion slots), which is associated with a specialized fingerprinting antenna for EMI fingerprint characterization of computing systems. A first plane 1010 of seating surface 805 is offset laterally from a second plane 1015 of dummy edge finger 730 to a center of a volume allocated for two expansion cards. This offset is greater than the offset in the single-width frame. However, in one embodiment, the offset of the front side 765 from dummy edge finger 730 for double-width frame 1005 remains consistent with the offset of front side 765 in single width frame 705. The position of the double width frame 1005 is thus indexed off of a first (rightmost, from the east view) of two expansion connectors in two adjacent expansion slots. When seated on seating surface 805 of double-width frame 1005, the planar antenna printed on PCB 300 is supported at a lateral middle of the CEM for a double expansion slot. The double-width frame 1005 provides additional clear volume around the planar antenna of PCB 300, which may increase the EMI readable by the antenna. Triple-width (and wider) frames may also be constructed to increase clear volume around the antenna.

FIG. 11 illustrates an exploded 3D view 1100 of PCB 300 seated in and attached to frame 705 along with an I/O bracket 1105 and associated components 1110 for attachment to frame 705 and PCB 300, which are associated with a specialized fingerprinting antenna for EMI fingerprint characterization of computing systems. PCB 300, frame 705, and I/O bracket 1105 and associated components 1110 may be assembled to form a fingerprinting antenna assembly (for example as shown and described with reference to FIGS. 12 and 13). Associated components 1110 include screws 1115, washer 1120, nut 1125, cap 1130, and tether 1135.

In one embodiment, I/O bracket 1105 is formed from conductive material, such as steel. For example, I/O bracket 1105 may be a pressed steel shape that conforms to specifications for an expansion slot bracket. I/O bracket 1105 includes screw holes 1140 and connector hole 1145 through a vertical wall of I/O bracket 1105. A screw hole 1140 is of sufficient diameter to allow passage of the threaded shank of screw 1115, and to not allow passage of the head of screw 1115. Screw holes 1140 align with pilot holes 755 in attachment surface 740. Connector hole 1145 is of sufficient diameter to allow passage of the threaded barrel 1150 (or other outer interface) of the radiofrequency connector 120, and not to allow passage of washer 1120 or nut 1125.

In one embodiment, screws 1115 may be self-tapping so as to cut into the plastic of frame 705 through the cylindrical walls of pilot holes 755 when screws 1115 are installed. In one embodiment, the walls of pilot holes 755 may be threaded with a thread that mates with that of screws 1115. In one embodiment, screws 1115 are made of conductive material, such as steel. In one embodiment, screws 1115 have a shank diameter of approximately 4 mm, such as a 4 mm screw or a No. 8 screw. Larger or smaller diameters may also be appropriate. In one embodiment, screws 1115 are of a length that protrudes only minimally into the volume of the expansion slot when installed so as to minimize the influence of screws 1115 on the RF response of the antenna. For example, screws 1115 might have a shank length of less than 10 mm. Screws 1115 may have a star, square, Allen, Phillips, slot, or other drive socket.

In one embodiment, washer 1120 is a locking washer. In one embodiment, locking washer 1120 is made of conductive material, such as brass. In one embodiment, the inner diameter of washer 1120 is of sufficient diameter to allow passage of the threaded barrel 1150 of radiofrequency connector 120. Nut 1125 is threaded about an interior circumference to engage with and twist onto threaded barrel 1150. In one embodiment, nut 1125 is made of conductive material, such as brass. When assembled, locking washer 1120 is compressed between an outer face of I/O bracket 1105 and an inner face of nut 1125 to resist loosening of nut 1125. In one embodiment, nut 1125 is a locking nut, and washer 1120 is not used. In one embodiment, a liquid thread locker may be applied between nut 1125 and threaded barrel 1150 to resist loosening of nut 1125.

In one embodiment, I/O bracket 1105 is a low-profile bracket, for example having an overall height of approximately 79.2 mm to fill, cover, or otherwise close a low-profile connector opening in the chassis. In one embodiment, I/O bracket 1105 is a standard (that is, full-height) I/O bracket, for example having an overall height of approximately 120.0 mm to fill, cover, or otherwise close a standard height connector opening in the chassis. In double- and triple-width fingerprinting antenna assemblies, I/O bracket 1105 may be a two slot or three slot I/O bracket, respectively.

In one embodiment, I/O bracket 1105 is affixed to frame 705 with screws 1115, and also affixed to PCB 300 with locking washer 1120 and nut 1125. For example, an inner vertical surface of I/O bracket 1105 is compressed against attachment surface 740 of frame 705 by passing the shanks of screws 1105 through screw holes 1140 and threading the screws into pilot holes 755. And, (SMA) radiofrequency connector 320 is mechanically held in place in connector hole 1145 of I/O bracket 1105 by nut 1125 engaging with threaded barrel 1150 and compressing washer 1120 against an outer vertical surface of I/O bracket 1105. In this configuration, the frame 705 and I/O bracket 1105 provide rigid mechanical support for the PCB 300 antenna.

Cap 1130 is a closure for radiofrequency connector 320. Cap 1130 is an open circuit connector cap that is configured to cover and protect radiofrequency connector 320 (and the antenna region 110) when radiofrequency connector 320 is not connected to a feedline. Cap 1130 is configured to electrically isolate the antenna region 310 from EMI external to a computer chassis when in place on radiofrequency connector 320. In one embodiment, cap 1130 is configured to engage with the grounded outer interface of radiofrequency connector 320 and cover the signal lead of radiofrequency connector 320. Cap 1130 is configured to be electrically insulated from the signal lead of radiofrequency connector 320, for example by an air gap. In one embodiment, cap 1130 is formed of conductive material, such as brass.

In one embodiment, where the radiofrequency connector 320 has a threaded barrel 1150, such as for an SMA connector, cap 1130 is a concave threaded closure that is threaded about an interior circumference to engage with and twist onto threaded barrel 1150. Other forms of mechanical engagement between cap and connector that are compatible with other connector types are also contemplated here, such as, for example, a snap-on engagement for affixing cap 1130 to an SMB connector or a bayonet-style engagement for affixing cap 1130 to a BNC connector.

When in place on radiofrequency connector, cap 1130 shuts off the antenna from influencing EMI responsiveness of a computing device in which the antenna is installed. Without cap 1130 (or a feedline to another system) in place on radiofrequency connector 320, for example, electrostatic discharge may infiltrate the chassis through the antenna and damage components. To protect against external EMI influence on a computing device, cap 1130 is put in place on radiofrequency connector 320 when radiofrequency connector 320 is not connected to a feedline of an EMI scanning system. When cap 1130 is in place, the antenna has minimal to no impact on operations of a computing device in which the antenna is installed.

To prevent loss of cap 1130, and potential infiltration of external EMI into a computing device in which the antenna is installed, Cap 1130 is affixed to I/O bracket 1105 by a tether 1135. In one embodiment, tether 1135 includes a chain 1155 (or other flexible harness such as a cord, lanyard, band, or strap) having an eyelet connector 1160 and a cap connector 1165 affixed at opposite ends of chain 1155. In one embodiment, chain 1155 is a beaded chain (also referred to as ball chain). Tether 1135 is attached at a first end to cap 1130 by cap connector 1165. In one embodiment, cap connector 1165 is configured to retain cap 1130 and chain 1155 in a rotatable connection that allows the cap to be twisted onto and off of radiofrequency connector 320. Tether 1135 is attached at a second end to the exterior surface of the I/O bracket 1105 by eyelet connector 1160 and one of screws 1115.

FIG. 12 illustrates a 3D front view 1200 of an expansion card 1205 assembly that is associated with a specialized fingerprinting antenna for EMI fingerprint characterization of computing systems. PCB 300 is seated on seating surface (not visible) of frame 705 and attached to frame 705 by push-pin rivets 715. In 3D front view 1200, a primary (printed) surface of PCB 300 faces toward the front, towards the seating surface of the frame 705. I/O bracket 1105 is mechanically and conductively connected to radiofrequency connector 320 by washer 1120 and nut 1125 threaded snugly onto threaded barrel 1150. I/O bracket 1105 abuts and is attached to attachment surface 740 of frame 705 by screws 1115. Cap 1130 is in place and threaded onto threaded barrel 1150. Cap 1130 is harnessed to I/O bracket 1105 by tether 1135. Tether 1135 is connected at one end to I/O bracket 1105 by a screw 1115.

FIG. 13 illustrates a 3D rear view 1300 of expansion card 1205 assembly that is associated with a specialized fingerprinting antenna for EMI fingerprint characterization of computing systems. In 3D rear view 1300, a secondary (unprinted) surface of PCB 300 faces toward the rear, away from the seating surface of the frame 705. In one embodiment, the primary (printed) surface of PCB 300 faces toward the rear of the frame 705, and the secondary (unprinted) surface of PCB 300 faces toward the front. PCB 300 is held in place against seating surface (not visible) of frame 705 and attached to frame 705 by push-pin rivets 715.

### —Selected Features of Example Fingerprinting Antenna Expansion Card—

In one embodiment, in the expansion card 1205, the nonconductive frame 705 includes a dummy edge finger 730 that is configured for mechanically engaging an expansion connector in an expansion slot of a computer system. And, the nonconductive frame 705 supports the planar antenna (e.g., PCB 300) in a location (atop seating surface 605) that is offset laterally from the dummy edge finger 730 towards a center of an electromechanical volume allotted to the expansion card by dimensional specifications.

In one embodiment, the expansion card 1205 has a form factor confirming to dimensional specifications of a low-profile PCIe expansion card.

In one embodiment, in the expansion card 1205, the dielectric substrate 305 of the planar antenna and nonconductive frame 705 further comprise holes 370, 710 in a plurality of corners. Pairs of the holes 370, 710 in corresponding corners of the dielectric substrate 305 and the nonconductive frame 705 are aligned. The expansion card 1205 also includes push-pin rivets 715 installed though the aligned pairs of holes 370, 710 to affix the planar antenna (e.g., PCB 300) to the nonconductive frame 705.

In one embodiment, where the connector is a radiofrequency connector 320 (that is electrically connected directly to antenna region 310), expansion card 1205 includes a cap 1130 for the radiofrequency connector 120. A tether 1135 is attached at a first end to cap 1130 and at a second end to the exterior surface of the I/O bracket 1105.

—Example Computer with Fingerprinting Antenna Expansion Card—

FIG. 14 illustrates a perspective view of an example target computer system 1400 having antenna expansion card 1205 installed within a chassis 1405 of the computing system 1400, which are associated with a specialized fingerprinting antenna for EMI fingerprint characterization of computing systems. In one embodiment, computer system 1400 includes chassis 1405, various computing components situated within the chassis 1405, expansion slot(s) 1410 within the chassis 1405 that include expansion connector(s) 1415, and the expansion card 1205 installed in one of the expansion card slots 1410. The computing components generate EMI when the computing components are operating. In one embodiment, PCB 300 is configured to be installed in an expansion slot of a target computer system 1400 as an antenna expansion card 1205. In the installation, frame 705 orients the antenna region 310 and ground regions 315 within an interior of a chassis of a target computer system, and the connector (such as radiofrequency connector 320) extends to an exterior of the chassis of the target computer system 1400.

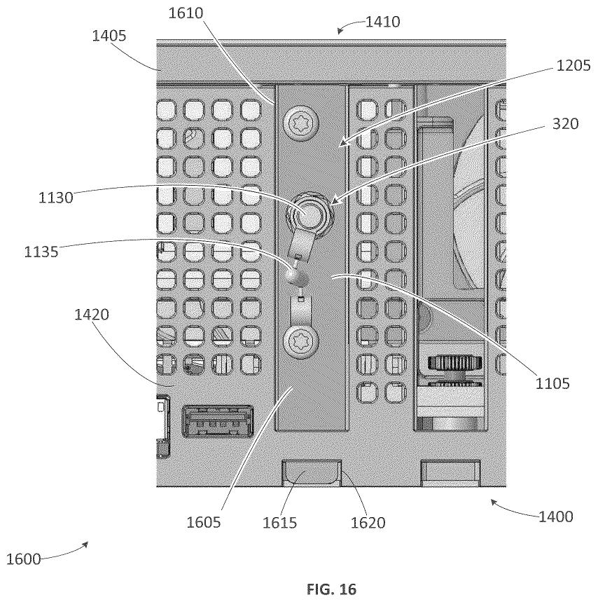

As discussed above, the antenna expansion card 1205 includes nonconductive frame 705 that has a dummy edge finger 730. Dummy edge finger 730 is configured to mechanically engage the expansion connector 1415 of the expansion slot 1410 that the expansion card 1205 is installed in. Antenna expansion card 1205 includes a broadband antenna (such as antenna region 310) printed in conductive material on a dielectric substrate (such as shown and described with reference to PCB 300). The broadband antenna 310 is held by nonconductive frame 705 at a lateral center of the expansion slot 1410 in which expansion card 1205 is installed, as shown in FIG. 15. Antenna expansion card 1205 also includes an I/O bracket 1105. I/O bracket 1105 is affixed to nonconductive frame 705 and to chassis 1405 of target computing system 1400. Antenna expansion card 1205 also includes a connector (such as radiofrequency connector 320), which is communicably coupled to (e.g., electrically connected to) the broadband antenna (antenna region 310). Radiofrequency connector 320 is accessible from outside the chassis 1405 on an exterior surface of I/O bracket 1105, as shown in FIG. 16.

In one embodiment, antenna expansion card 1205 is installed in chassis 1405 in a particular expansion slot 1410 when a bottom or south tip of I/O bracket 1105 is inserted into an I/O bracket slot (not visible, see FIG. 16) associated with the expansion slot 1405, and dummy edge finger 730 engages with an expansion connector 1415 that is associated with the expansion slot 1405. The I/O bracket slot is along a bottom edge of an I/O wall 1420 of chassis 1405, below an I/O opening (not visible, see FIG. 16) associated with the expansion slot 1410. In one embodiment, installation further includes affixing a flange at the top of I/O bracket 1105 to a bracket ledge 1425, for example with a clip 1430 or screw. Mechanical engagement of the I/O bracket 1105 with the chassis 1405 at the I/O bracket slot and bracket ledge 1425, and mechanical engagement of frame 705 with dummy edge finger 730 to expansion connector 1415 on a motherboard 1435 (which is affixed to chassis 1405) forms a rigid and vibrationally stable connection between antenna assembly 1205 and chassis 1405. The positioning of antenna assembly 1205 in this manner is repeatable, both for removal and reinsertion of antenna assembly 1205 in one chassis 1405, and for placement of an antenna assemblies 1205 in a known position in a plurality of chassis 1405.

Expansion connectors 1415 are configured to accept insertion of edge fingers of expansion cards. Because the expansion connectors 1415 are used to provide a mechanical indexing location for the antenna expansion card 1205, and not to communicate data, the particular type of the expansion connectors 1415 is relevant mainly for the mechanical positioning and sizing of dummy edge finger 730. In one embodiment, antenna expansion card 1205 is configured to mechanically engage one or more types of expansion connectors with dummy edge finger 730. In one embodiment, expansion connectors 1415 may include peripheral component interconnect (PCI), peripheral component interconnect express (PCIe), accelerated graphics port (AGP), industry standard architecture (ISA), and a wide variety of other standard and custom expansion interfaces. The PCIe expansion connectors may have a variety of sizes, such as PCIe x1, PCIe x2, PCIe x4, PCIe x8, PCIe x12, PCIe x16, or PCIe x32, or connectors with even higher numbers of data lanes. The PCI expansion connectors may be standard PCI or PCI-X connectors.

Antenna expansion card 1205, in one embodiment, is not in electronic communication with the computer system in which it is installed. Instead, antenna expansion card 1205 is isolated from the data operations of the target computer system. In other words, antenna expansion card 1205 is a probe that is external to the computing activities of the target computer system 1400, while being physically positioned within the chassis 1405 of the target computer system 1400. The position of antenna expansion card 1205 is in a known location that is mechanically registered off of features of the expansion slot 1410. The antenna expansion card 1205 (and the PCB-based planar broadband antenna therein) are thus “passive” components with respect to the target computer system, and do not interact with operations of the target computer system. In practical effect, because (in one embodiment) the antenna expansion card does not communicate with pins of the expansion connector, the antenna expansion card may be hot swapped—that is, inserted or removed while the target computer system is operating.

Referring now to FIG. 15, FIG. 15 illustrates a top view 1500 of example target computer system 1400 having antenna expansion card 1205 installed within a chassis 1405 of the computing system 1400, which are associated with a specialized fingerprinting antenna for EMI fingerprint characterization of computing systems. Expansion card 1205 is installed in an expansion slot 1410. As mentioned above, the broadband antenna (antenna region 110) is held at a lateral center 1505 of a volume 1510 allotted to the expansion slot 1410. In one embodiment, volume 1510 extends between a bottom or southern plane above motherboard 1435 in chassis 1405 to a top or northern plane below a top closure of chassis 1405. More particularly, expansion card 1205 holds the conductive trace that makes up antenna region 110 in a plane that is substantially parallel to and centered between sides of volume 1510. The lateral center 1505 plane of expansion slot 1410 is offset from—and substantially parallel to—a plane 1515 of a slot of an expansion connector 1415 for expansion slot 1410.

Referring now to FIG. 16, FIG. 16 illustrates a rear (west end) view 1600 of example target computer system 1400 having antenna expansion card 1205 installed within chassis 1405 of the computing system 1400, which is associated with a specialized fingerprinting antenna for EMI fingerprint characterization of computing systems. View 1600 is from an exterior of chassis 1405. Exterior surface 1605 of I/O bracket 1105 is visible through I/O opening 1610 in I/O wall 1420. A bottom or south tip 1615 of I/O bracket 1105 is inserted into an I/O bracket slot 1620. Tip 1615 is engaged with and retained by slot 1620. Radiofrequency connector 320 extends outward from exterior surface 1605 beyond the plane of I/O wall 1420 of chassis 1405. Radiofrequency connector 320 (as well as covering cap 1130 and tether 1135) are thereby rendered accessible at the exterior of chassis 1405. A feedline to an EMI scanning system may be attached to radiofrequency connector 320 from outside of the target computing system 1400. The feedline has a mating connector that is compatible with connection to radiofrequency connector 320.

In an alternative embodiment, the expansion slots include disk drive slots of a disk drive bay or enclosure, and the antenna expansion card 1205 is configured to engage with and occupy one or more disk drive slots. For example, the frame 705 may be configured to engage with and index position off of one or more latches, rails, releases, drive connectors such as SATA or SAS connectors, walls of the disk drive bay or slot, or other physical features of the disk drive slot. In this way, the position of the broadband antenna is mechanically registered on one or more physical features of the disk drive slot. In one embodiment, frame 705 is configured to hold PCB 300 in a middle of the disk drive slot, for example at a plane dividing the volume of the disk dive slot at a center of the shortest (or height) dimension. The antenna expansion card 1205 may be configured to conform with the form factor of the disk drive slot, for example with one of the 2.5-inch, 3.5-inch, or 5.25-inch form factors. Depending on the configuration of the target computing device 1400, installation of the antenna expansion card in the disk drive bay may reduce sensitivity to EMI in comparison with installation in expansion card slots. For example, the expansion card slots are generally more proximate to processors, memory, and other solid state electronic components than are the disk drive slots. The expansion card slots are therefore closer to the widest variety of EMI sources within the chassis than are the disk drive slots, increasing sensitivity to EMI.

### —RF Characteristics of Example Antenna—

As mentioned above, the EMI fingerprinting antenna (e.g., antenna region 310) is a broadband antenna. A broadband antenna operates to receive signals across a broad range of frequencies in a frequency spectrum, for example without significant degradation in performance. The broadband antenna is not specifically configured to operate at an individual frequency. Instead, the broadband antenna has an ability to operate across a wide span of frequencies, ranging from lower to higher frequencies, providing comprehensive coverage across most or all of the frequencies within the range. The broadband antenna supports frequencies across the spectrum of interest, providing relatively consistent performance across different frequencies. For example, in one embodiment, the broadband antenna covers the Ultra High Frequency (UHF) range of radiofrequencies from 300 MHz to 3 GHz. In one embodiment, the broadband antenna covers frequencies from 600 MHz to 3.2 GHz.

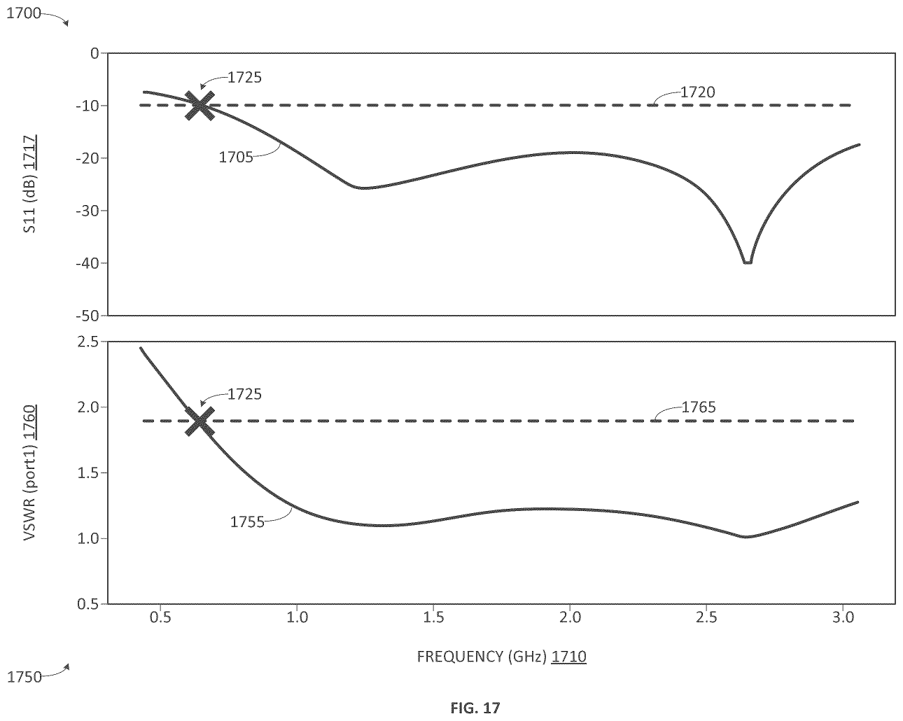

Return Loss (RL) and Voltage Standing Wave Ratio (VSWR) are two parameters used to characterize the performance of antennas. Referring now to FIG. 17, FIG. 17 illustrates a first plot 1700 of return loss 1705 and a second plot 1750 of voltage standing wave ratio 1755 for an example EMI fingerprinting antenna associated with EMI fingerprint characterization of computing systems that is configured as shown and described with reference to FIGS. 3-13. Return loss 1705 of the example EMI fingerprinting antenna is plotted against a frequency axis 1710 and an RL amplitude axis 1715. Voltage standing wave ratio 1755 is plotted against frequency axis 1710 and an VSWR amplitude axis 1760. The RL 1705 and VSWR 1755 for the example EMI fingerprinting antenna are measured across a broad range of frequencies from 0.4 GHz to 3.2 GHZ.

Return loss 1705 is a measure of the amount (that is, amplitude) of power reflected back from the example fingerprinting antenna due to impedance mismatches at a given frequency. Return loss 1705 is expressed in decibels (dB) and is calculated as the ratio of the power of the incident wave to the power of the reflected wave. In general, lower amplitudes of return loss 1705 indicate better impedance matching, less signal loss, and therefore higher sensitivity to RF radiation at a given frequency. For broadband sensitivity, the example EMI fingerprinting antenna exhibits a consistently low return loss of less than −10 dB across a wide frequency range from 0.6 GHz 1725 to 3.2 GHZ (and beyond). In one embodiment, RL loss below-10 dB indicates satisfactory sensitivity for EMI fingerprinting of computing equipment, although higher values for RL loss may also be acceptable, for example RL loss below-5 dB, or even-1 dB.

VSWR 1755 is another measure of impedance matching in the example EMI fingerprinting antenna. VSWR 1755 and quantifies the ratio of the maximum voltage (standing wave) to the minimum voltage from the antenna through the signal lead of RF connector 320 (or along a feedline connected to RF connector 320). In general, lower amplitudes of VSWR 1755 indicates better impedance matching, less signal reflection, and therefore higher sensitivity to RF radiation at a given frequency. For broadband sensitivity, the example EMI fingerprinting antenna exhibits a consistently low VSWR 1755 of less than 1.9:1 across a wide frequency range from 0.6 GHz 1725 to 3.2 GHZ (and beyond). In one embodiment, VSWR below 1.9:1 indicates satisfactory sensitivity for EMI fingerprinting of computing equipment, although higher values for VSWR may also be acceptable, for example VSWR below 2:1, or even 3:1.

In one embodiment, the example EMI fingerprinting antenna (e.g., antenna region 310) has a response that is symmetrical about its own lengthwise, axis, and has a response biased away from the west, exterior end of the expansion card, and toward the east, interior end of the expansion card. Thus, when installed in an expansion slot, the example EMI fingerprinting antenna (e.g., antenna region 310) has a response that is symmetrical about a lengthwise axis of the expansion slot in which it is installed. And, the response is biased toward an interior of the chassis.

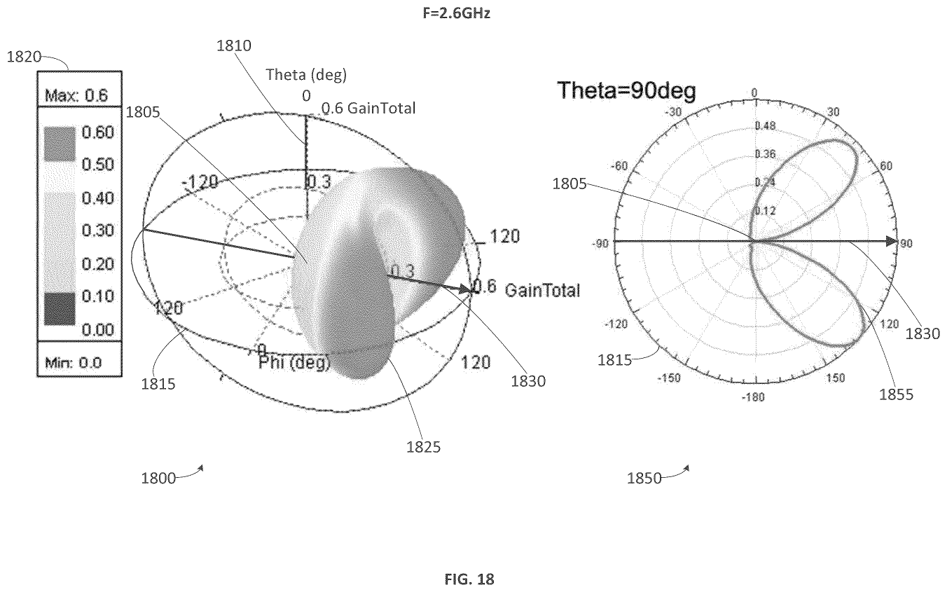

For example, FIG. 18 illustrates a 3D gain plot 1800 and a 2D gain plot 1850 at a frequency of 2.6 GHz for the example EMI fingerprinting antenna associated with EMI fingerprint characterization of computing systems. The origin point 1805 of the gain plots is a point at the vertical center of the transition from a narrow end of a triangular antenna region (such as antenna region 310) and a throat (such as throat 325). In one embodiment, point at the vertical center of the transition is an excitation point of a coplanar waveguide defined by throat 325 and flanking straight edges of ground regions 315a, 315b. A pole 1810 extends vertically (in a north-south orientation) through origin point 1805. A reference plane 1815 extends through origin point 1805 at an angle perpendicular to pole 1810. Reference plane 1815 coincides with a plane of the conductive trace of antenna region 310 and throat 325. For example, reference plane 1815 may be centered laterally within the conductive layer. In 3D gain plot 1800, the radial distance (r) from the origin point is shown by the various shadings given in key 1820. A Y axis 1830 extends through origin point 1805 in reference plane 1815 perpendicularly to pole 1810 (a Z axis) and an X axis in reference plane 1815.

3D gain plot 1800 shows a 3D radiation pattern 1825 for the example EMI fingerprinting antenna at a frequency of 2.6 GHz. 2D gain plot 1850 shows a 2D radiation pattern 1855 in the reference plane 1815 for the example EMI fingerprinting antenna at a frequency of 2.6 GHz. The 3D radiation pattern 1825 and 2D radiation pattern 1855 show that, at 2.6 GHZ, the example EMI fingerprinting antenna has a response that is symmetrical about a Y axis 1830 of the antenna. And, the response prefers the positive direction (which is eastward in the PCB 300, toward the interior of chassis 1405 when installed) from the origin along the Y axis 1830.

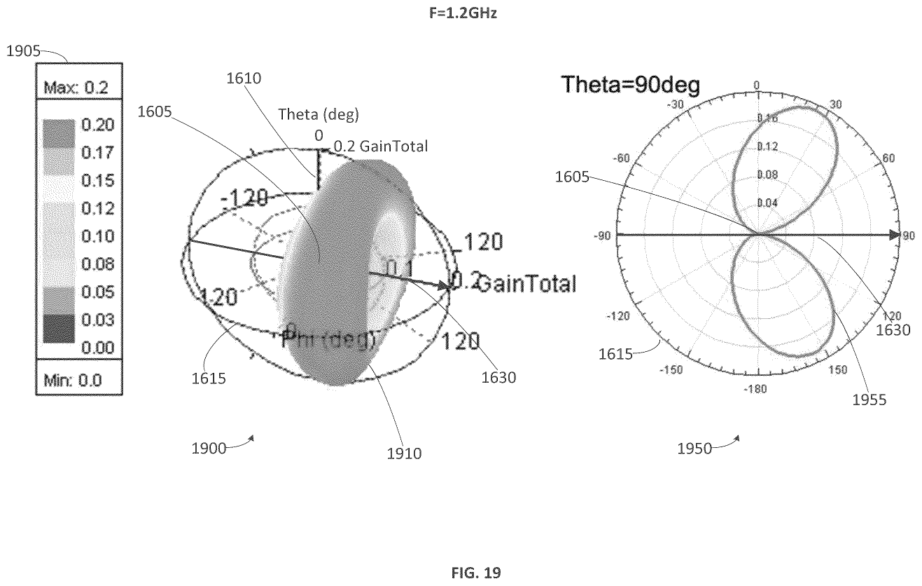

FIG. 19 illustrates a 3D gain plot 1900 and a 2D gain plot 1950 at a frequency of 1.2 GHz for the example EMI fingerprinting antenna associated with EMI fingerprint characterization of computing systems. In 3D gain plot 1900, the radial distance (r) from the origin point is shown by the various shadings given in key 1905. 3D gain plot 1900 shows a 3D radiation pattern 1910 for the example EMI fingerprinting antenna at a frequency of 1.2 GHz. 2D gain plot 1950 shows a 2D radiation pattern 1955 in the reference plane 1815 for the example EMI fingerprinting antenna at a frequency of 1.2 GHz. The 3D radiation pattern 1910 and 2D radiation pattern 1955 show that, at 1.2 GHz as well, the example EMI fingerprinting antenna has a response that is symmetrical about Y axis 1830 of the antenna, with the preference for the positive direction from the origin along the Y axis 1830.

The antenna response that is symmetrical about Y axis 1830, with a preference or bias toward the positive (eastward) direction towards the interior of the chassis 1405 provides reception coverage of the interior of the chassis 1405. To take advantage of this response pattern when collecting EMI within the chassis 1405 of target computer system 1400, in one embodiment, the expansion slot in which the example EMI fingerprinting antenna is installed is closest to a lateral centermost position within the chassis 1405. The lateral center of the chassis 1405 is a plane midway between the side walls of the chassis. For example, the side walls are exterior chassis walls that are substantially perpendicular to I/O wall 1420 and substantially parallel to center 1510 planes of expansion slots 1410.

Or, in another embodiment, the expansion slot in which the example EMI fingerprinting antenna is installed is closest to a signal (EMI) hotspot within the chassis 1405. EMI hotspots in the chassis 1405 can exist due to a variety of causes. For example, EMI hotspots may occur in proximity to high-speed components (e.g. processors, memory modules, or high-speed busses) which generate rapid changes in electric currents and attendant radiofrequency EMI. And, for example, EMI hotspots in the chassis may also be due to resonance effects, in which EMI interacts with structural elements or other electronics within the chassis 1405, amplifying EMI at specific areas. Positions of EMI hotspots within chassis 1405 may be detected by an initial survey (of the target computer system 1400 or of a reference computer system of a type similar to that of target computer system 1400) to find positions at which EMI peaks within the chassis 1405.

—Selected Features of Example Computer with Fingerprinting Antenna Expansion Card—

In one embodiment, in the example target computer system 1400, the broadband antenna has a response that is symmetrical about a lengthwise axis of the expansion slot and biased toward an interior of the chassis.

In one embodiment, in the example target computer system 1400, the expansion slot in which the expansion card 1205 is installed is closest to one of (i) a lateral centermost position within the chassis or (ii) a signal hotspot within the chassis.

In one embodiment, in the example target computer system 1400, the expansion card 1205 is not in electronic communication with the computer system.

As discussed in further detail below with reference to FIG. 20, in one embodiment, the example target computer system 1400 is further includes an EMI scanning system (such as EMI scanning system 2000) that is external to the example target computer system 1400. The EMI scanning system includes a radio receiver that is electrically connected to the broadband antenna, for example through a feedline between the radiofrequency connector and an antenna input of the radio receiver. The radio receiver is configured to output readings of the radiofrequency EMI sensed using the antenna expansion card 1205. The EMI scanning system includes a processor and memory that are communicably coupled to the radio receiver, and which are configured to receive readings of the radiofrequency EMI taken by the radio receiver. The EMI scanning system includes one or more non-transitory computer-readable media including instructions that, when executed by the processor accessing the memory, cause the EMI scanning system to detect that one of the computing components behaves anomalously. The detection is based on a difference between readings of radiofrequency EMI sensed within the computer system by the broadband antenna and machine learning estimates of radiofrequency EMI for a reference computer system. The EMI scanning system includes a display configured to show an indication when the one of the computing components has been detected to behave anonymously.

### DISCUSSION AND FURTHER EMBODIMENTS

Counterfeit electronic components in international supply chains are a $250B per year problem that exists across industries that use electronics. Although counterfeit components were mostly a costly nuisance for IT systems, it has become a safety-critical issue for military and transportation systems. A US Senate Committee on Armed Services found that over 1-million counterfeit components have been found in all electronic systems in the US DoD. Despite intense efforts to tighten supply-chain checkpoint procedures throughout the world, the problem of counterfeit electronic components continues.

More insidiously, spychips may be surreptitiously incorporated into computer systems or their electronic components. The spychips may enable software/firmware modification, data breaches and exfiltration, unauthorized access or control, malware propagation and persistence, unauthorized surveillance, and espionage. These may result in damage to equipment, economic damage, loss of reputation and trust, and legal and regulatory noncompliance by the owners, operators, or users of the compromised computer systems. Documented cases of spychips discovered in computing equipment are growing in number.

Further, computers and their electronic components can degrade over time and with use due to various factors including physical wear and tear, thermal stress, electrical, stress, and environmental factors. Many failure modes alter the nominal EMI profile of the computers and their components. For example, hardware failure may cause voltage fluctuations or increased electrical noise, thus changing the EMI profile. Or, for example, thermal stress may cause semiconductor junctions to leak current, thus changing the EMI profile. Or, in another example, electrical stress such as voltage fluctuations and power surges may exacerbate electromigration or oxide breakdown, again changing the EMI profile. In yet another example, unanticipated rapid aging of components, such as the development of tin whiskers on solder joints also changes the EMI profile.

Electromagnetic interference (EMI) fingerprinting refers to techniques to identify component configurations of electronic devices based on the unique electromagnetic signals given off by a particular configuration during operation. EMI fingerprinting may be used to (i) detect presence of counterfeit components in electronic systems, (ii) detect presence of SpyChips—devices surreptitiously incorporated into an electronic system to modify software or firmware, exfiltrate data, or perform other malicious activities—in electronic systems, and/or (iii) detect degradation of electronic components over time.

For example, radiofrequency EMI signals—which emanate from all operating electronics—may be captured from a computer system using scanning equipment including an antenna and radio receiver to produce an EMI fingerprint for the computer system. A “Golden System EMI Fingerprint” is created on a reference computer system for which engineers certify there are only authentic internal components (no spychips or counterfeits) in a known state of degradation. A “Target System EMI Fingerprint” is created on a target computer system for which the status of component authenticity and state of degradation may be unknown. The Golden System and Target System EMI Fingerprints are compared to passively detect (i) the presence of internal counterfeit electronic components, SpyChips, or degradation; or (ii) the absence of counterfeits, SpyChips, or degradation.

Thus, radiofrequency antennae are used to gather the EMI of a target computer (or other) system, which may then be analyzed to detect SpyChips (or other modchips), counterfeit component, or the incipience or progression of component degradation. The quality of the EMI Fingerprint is largely dependent on the performance of the antenna in the EMI scanning system. External hand-held wand antennas, magnetic-mount external antennas, and customized server lids that include antennas can work for generation of EMI fingerprints, but these solutions suffer from a number of drawbacks.

Hand-held and magnetic-mount antennas suffer from variability in positions and orientations at which technicians or engineers hold or mount the antennas. For example, a hand-held “wand”-style antenna might be used to pick up EMI signatures to detect the presence of tin whiskers, counterfeit components, developing degradation in solid-state components, or mod/spy chips. However, for EMI fingerprinting of multiple devices, humans who manually scan servers for internal anomalies may exhibit variability in the positions, the orientations, or the distances at which they hold the analysis wand (or affix the mag-mount) relative to the surfaces the server. This process variability affects the rate of false positives, as well as the rate of missed alarms (i.e., Type I and Type II errors).

And, for the large variety of make and model for datacenter, server, and personal computing devices in the world, there are too many variations for engineers to modify a customized server lid to adapt to the geometry changes. For example, a customized server top that has a long antenna affixed to its under-side surface (an “instrumented top”) may be substituted for the original server top during the EMI fingerprinting scan. In experimentation, the original server top may be opened, replaced with the instrumented top, the EMI fingerprinting scan completed, and the original top returned in under 15 minutes. But since the customized server lid is specific to the chassis employed by individual manufacturers, making the instrumented top available to many manufacturers is impracticable.

In one embodiment, a new approach to antennas for EMI fingerprint characterization is presented herein by incorporating a triangular monopole antenna that is customized and optimized for the task of collecting broadband EMI emissions within a computer chassis into an industry-standard expansion card, creating an insertable device that can be easily installed in servers and computers where an expansion slot is available. Expansion slots are generally available in computing devices, for example, PCI slots (and/or their successor PCIe slots) have been standard on motherboards since 1992. Therefore, in one embodiment, the antenna expansion card overcomes the challenges of prior-art EMI Fingerprint characterization of server systems with a novel EMI sensing technique and apparatus. In one embodiment, the antenna described herein is relatively low-cost, uniform, suitable for mass production, removes human variability in the scanning process, and can be applied to modern as well as legacy computing systems throughout the world. Further, in one embodiment, the scan may be accomplished without removing covers or cases, and without disassembling motherboards or other components.

In one embodiment, the antenna expansion card is a universal antenna in compliance with industry standards. In one embodiment, the antenna expansion card is generalizable to any server assets. In one embodiment, the antenna expansion card requires minimal attention, interaction, or training with respect to humans that are conducting the scans. In one embodiment, the antenna expansion card is a standard PCIe device, as PCI/PCIe slots have become standard on motherboards for 30 years. In one embodiment, the antenna expansion card is a triangular monopole antenna in the form factor of a standard low-profile PCIE card. In one embodiment, the antenna expansion card can therefore be inserted into the PCIE slot (or other expansion slot) that is generally available in servers.

Use of the antenna expansion card for EMI fingerprint scanning makes it extremely easy to periodically collect or check the EMI fingerprint of the servers in the supply chain, or at ports of entry, or when servers are received by a datacenter customer as part of initial setup preparation and testing. The repeated testing may be performed to ensure no counterfeits or mod chips are installed anywhere between manufacturing and “assembly” plant, which can be in a different country or in transit between the assembly factory and the customer datacenter.

In experimental testing, the antenna expansion card was used successfully both (i) to detect unwanted electronic components and (ii) to distinguish different server types using two configurations of Oracle® X8-2L servers.

In one embodiment, the PCB fingerprinting antenna and antenna expansion card may be used generally in the application areas for printed circuit boards, including applications in medical devices, industrial equipment, automotive, lighting, LEDs, security applications, communications, computer and servers, home appliances, monitors, navigation, scanning equipment, consumer electronics, transportation and transportation systems, aerospace and space components, marine applications, military and defense appliances and applications, measuring equipment, gaming electronics, recording devices, and other for printed circuit boards. Moreover, the antenna expansion card solution not only applies to legacy server systems, but also applies wherever standardized expansion slots are available in electronic equipment. These expansion slots may vary in dimensions of available card electromechanical volume based on the standard applicable to the expansion slot, but in general, an antenna expansion card as described herein may be configured to conform to the dimensional specifications of the expansion slot. The antenna expansion card therefore finds application for EMI fingerprinting across a wide variety of industries.

For example, telecommunication equipment such as routers as routers, switches, and modems used in telecommunications networks often feature expansion slots to accommodate additional network interface cards (NICs), expansion modules, or interface cards for connecting to different types of networks or adding specialized functionality. And, for example, industrial control systems, including programmable logic controllers (PLCs), distributed control systems (DCS), and supervisory control and data acquisition (SCADA) systems, may incorporate expansion slots to support additional input/output (I/O) modules, communication interfaces, or specialized control modules for interfacing with sensors, actuators, and other industrial equipment. Also, for example, test and measurement instruments such as oscilloscopes, spectrum analyzers, and signal generators often include expansion slots for adding modular measurement modules, interface cards, or specialized analysis tools to extend the capabilities of the instrument or accommodate specific testing requirements. In another example, professional audio and video equipment, including mixers, amplifiers, video routers, and digital signal processors, may feature expansion slots for adding audio interface cards, video processing modules, or networking interfaces to integrate with other equipment or expand the device's functionality. In a further example, medical devices and equipment, such as patient monitors, imaging systems, and diagnostic instruments, may incorporate expansion slots for adding specialized measurement modules, communication interfaces, or data acquisition cards to support specific medical applications or integrate with hospital networks. In yet another example, radar and electronic warfare (EW) systems used in military aircraft, ships, and ground-based installations may incorporate expansion cards to support additional radar modes, signal processing algorithms, or EW techniques.

In one embodiment, the novel and low-cost antenna design shown and described herein overcomes challenges to EMI fingerprint characterization of servers and other electronic equipment for detection of component degradation or of counterfeits, spychips, or other unwanted components; removes human variability in the EMI fingerprint scanning process; and makes EMI fingerprinting generally applicable to any legacy computing systems (or other electronic computer systems) where an expansion slot is available.

In one embodiment, the antenna expansion card integrates a specialized antenna into an expansion card filler module (such as the combination of frame 705 and I/O bracket 905) that complies with an industry standard for the expansion card and can be used as an insertable device. In one embodiment, the antenna expansion card integrates a broadband antenna into a PCIe filler, for example integrating a triangular monopole antenna on a FR4 PCB, a surface mount SMA connector, and a PCIE filler module. In this configuration, the antenna expansion card can be used as an insertable device for modern and legacy enterprise servers. And, in this configuration, experimentation has demonstrated the antenna expansion card to produce high-fidelity EMI fingerprints.

As of 2022, the Federal Acquisition Regulations (FARs) require that all suppliers to any Government agencies certify the absence of Counterfeits and SpyChips. Advantageously, in one embodiment, the antenna expansion card particularly addresses the counterfeit and spychip challenges for all datacenter assets. In conjunction with EMI fingerprinting, the antenna expansion card may be used to passively detect and certify the absence of counterfeits and spychips.

Servers (and other computer systems) contain a variety of electronic components and chips running at different clock speeds. At present, the strongest EMIF signals emitted by the computer systems are in the UHF (300 MHZ-3 GHZ) range. Also, the servers have internal protocols for power distribution, so the EMI signal map follows certain time sequencies while executing different commands. In addition, a metal chassis is employed in the computer system to (i) avoid unwanted signal interreference as well as (ii) minimizing radiation outside the servers, in compliance with EMI regulations. Therefore, computer system environment for EMI fingerprinting can be approximated to a resonating metal cavity with multiple sources radiating towards random directions at UHF frequencies, creating local signal hotspots.

In one embodiment, a PCB fingerprinting antenna (e.g., PCB 300) is described herein, for example with reference to FIGS. 3-4. The PCB fingerprinting antenna is a planar triangular monopole antenna (e.g., antenna region 310) with flared ground (e.g., ground regions 315a, 315b). The PCB fingerprinting antenna has a single layer PCB with FR4 as the substrate (dielectric constant ∈=4.5, per manufacturer data). In one embodiment, the PCB fingerprinting antenna measures 60 mm wide by 105 mm long by 1.6 mm thick, for example as shown in FIG. 4.

As shown in FIGS. 3-5, in one embodiment the PCB fingerprinting antenna is configured to have a planar flared monopole configuration. The configuration planar flared monopole configuration enables coverage of as wide bandwidth as possible (at hotspot location selected for testing) within the geometric constraint limited by an express PCI card. The PCIe geometric constraint enables mass-production of the PCB and installation within the volume allotted to a PCIe expansion slot (for example as shown and described with reference to FIGS. 14-16). The monopole ensures omnidirectional collection of radiation pattern (for example as shown with reference to FIGS. 18 and 19). The triangular shape extends the operating bandwidth (here defined by return loss lower than-10 dB, VSWR below 1.9:1) above 600 MHz (to cover frequencies detected for internal signal maps from testing), with two optimum resonances at 1.2 GHz and 2.6 GHz. The measured data shifts the resonance frequencies to 1.3 GHZ and 2.45 GHz, which matches the strongest radiation signal from testing. In one embodiment, the PCB fingerprinting antenna is fed by coplanar waveguide excitation (e.g., as shown at throat 325) designed for a standard 50 Ohm end-launch SMA connector. In one embodiment, the grounds are flared with optimized spline curves for wideband impedance matching. In one embodiment, the PCB fingerprinting antenna design is applicable to the geometry of typical servers. In one embodiment, the resonance frequency of the PCB fingerprinting antenna can be readily tuned by multiple geometric parameters. As shown in FIGS. 18 and 19, the gain plots (1800, 1850, 1900, and 1950) of the radiation pattern of the PCB fingerprinting antenna shows that the PCB fingerprinting antenna has symmetrical response about a Y axis (labeled in FIG. 2), with a preference towards a positive direction (away from throat 325).

In one embodiment, the PCB fingerprinting antenna is integrated with a PCIE housing bracket (e.g., I/O bracket 1105, for example as shown with reference to FIGS. 11-13). In one embodiment, a low-profile PCIE back cover (e.g., frame 705, for example as shown with reference to FIGS. 7-13) is fastened on the PCB fingerprinting antenna. This assembly of the PCB fingerprinting antenna, housing bracket (frame), and back cover (I/O bracket) forms an antenna expansion card. In one embodiment, the antenna expansion card itself is configured to be installed in a way that provides a clearest EMI signal from the whole server to the PCB fingerprinting antenna. For example, when the antenna expansion card is installed, the PCB fingerprinting antenna is centered in the PCIe volume, to give as much clear space around the antenna elements as possible to reduce the effect of any PCIe cards installed next to the antenna. The antenna expansion card registers on the PCIe slot (e.g., using dummy edge finger 730) to allow for repeatable results with multiple insertions and removals of the card, and to reduce variation in the EMI fingerprint due to shock, vibration, or reinstallation of the antenna. Shock may be due to rough handling during shipping. Vibration may be due to operational vibration of the computer system (including resonant amplification of vibration) which may be caused, for example, by cooling fans. Positioning of the antenna is rendered consistent, rigid, and repeatable after removal and reinstallation by the third point connection of the card to the expansion connector in addition to the two points at the top and bottom of the I/O bracket. Thus, in one embodiment, a triangular monopole antenna is attached onto a PCIe housing bracket.

### —Example EMI Scanning System—

In one embodiment, an EMI scanning system that is external to target computer system 1400 is configured to collect EMI from target computer system 1400 through the broadband antenna expansion card 1205 installed within chassis 1405 of target computer system 1400. FIG. 20 illustrates an example EMI scanning system 2000 associated with specialized antenna for EMI fingerprint characterization of computing systems. In one embodiment, EMI scanning system 2000 includes a radio receiver 2001 electrically connected to the broadband antenna 2002 of antenna expansion card 1205. EMI scanning system 2000 includes a computer 2005, having a processor 2010 and memory operably communicably coupled to the radio receiver. EMI scanning system 2000 includes one or more non-transitory computer-readable media, such as computer-readable media 2037. Computer-readable media 2037 includes computer-executable instructions that, when executed by the processor accessing the memory, cause the EMI scanning system to detect that one of computing components 2003 within the chassis of target computer system 1400 behaves anomalously. The detection of the anomaly is based on a difference between (i) readings of radiofrequency EMI 2004 sensed within target computer system 1400 by broadband antenna 2002 and (ii) machine learning estimates of radiofrequency EMI for a reference computer system. In one embodiment, EMI scanning system 2000 includes a display 2070 that is configured to show an indication when the one of the computing components 2003 has been detected to behave anonymously.

Antenna expansion card 1205 (including broadband antenna 2003) is physically positioned within target computer system 1400 by being installed in an expansion slot of target computer system 1400. Broadband antenna 2002 is thus in position to collect radiofrequency EMI 2004 emitted within the chassis 1405 of computer system 1400, for example, radiofrequency EMI 2004 that is emitted due to operation of computing components 2003 of computer system 1400.

In one embodiment, radio receiver 2001 is configured to receive radiofrequency EMI 2004 picked up by broadband antenna 2002 and convert them to a format readable by computer 2005. In one embodiment, radio receiver 2002 is a software-defined radio (SDR) receiver. For example, radio receiver 2002 has a local oscillator (such as a crystal oscillator) configured to generate stable radiofrequency oscillations for reference in frequency synthesis. Radio receiver 2001 also includes a frequency synthesizer (such as a phase-locked loop frequency synthesizer) configured to generate frequencies from multiples of the oscillations of the local oscillator. Radio receiver 2001 may further include other radio front end hardware components, such as a signal amplifier. In one embodiment, Radio receiver 2001 includes a radiofrequency demodulator. Broadband antenna 2002 is thus communicably coupled to the radiofrequency demodulator, which in one embodiment, operates to extract the sensed EMI.

In one embodiment, radio receiver 2002 is configured to convert radiofrequency EMI 2004 from analog voltage variations induced in the broadband antenna 2003 to a stream of digital amplitude readings of the radiofrequency EMI 2004. The digital stream of amplitude readings is transmitted to computer 2005, for example through I/O ports 2020. In one embodiment, the stream of values is sampled by radio receiver 2002 at a sampling frequency that is at least twice the maximum frequency sensed by broadband antenna 2002, so as to effectively record radiofrequency EMI 2004 at the top end of the broadband spectrum of the broadband antenna 2002. For example, where the top of the broadband spectrum sensed by broadband antenna 2002 is 3.2 GHZ, radio receiver 2002 is configured to sample the radiofrequency EMI 2004 at a sampling frequency of 6.4 GHz or more.

In one embodiment, the computer executable instructions implement an expansion card antenna EMI fingerprinting logic 2030. (Logic 2030 is shown in FIG. 20. separately from other CRM 2037, storage 2035, memory 2015 for convenience.) In one embodiment, logic 2030 causes EMI fingerprinting system 2000 to perform an EMI fingerprinting scan of a target computing system using broadband antenna 2002 of antenna expansion card 1205. For example, EMI fingerprinting system 2000 is caused to detect whether one or more of computing components 2003 of target computer system 1400 are behaving anonymously using readings of radiofrequency EMI 2004 sensed by broadband antenna 2002. For example, the system 2000 collects readings of radiofrequency EMI 2004 using radio receiver 2001. The readings may, in one embodiment, be taken while computer system 1400 is executing a pre-determined test pattern of operations.

The EMI fingerprinting system 2000 compares the readings of radiofrequency EMI 2004 with reference readings of a reference computer system. The reference computer system is configured in a similar manner to target computer system 1400. For example, the reference computer system has one or more of the same types of components as compute components 2003, and which are installed in corresponding physical locations within a chassis of the reference computer system. In one embodiment, the reference computer system is a golden sample that is confirmed to be operating in a nominal manner that is undegraded from certain standards, and which is confirmed to be free of spychips and counterfeit components. In one embodiment, the reference readings used in the comparison are recorded while the reference computer system is executing the pre-determined test pattern. In one embodiment, the reference readings used in the comparison are generated by a machine learning model that is trained to generate estimates of the readings produced while the reference computer system is executing the pre-determined test pattern. In one embodiment, the machine learning model is a multivariate state estimation technique model configured to predict amplitude values in a set of frequency bins of the frequency spectrum sensed by broadband antenna 2002.

Where the readings of radiofrequency EMI 2004 with reference readings of the reference computer system differ so much as to satisfy an anomaly test (such as a sequential probability ratio (SPRT) test), the EMI fingerprinting system 2000 detects that one or more of the computing components 2003 is behaving anomalously. EMI fingerprinting system 2000 then generates an electronic alert or message indicating the detection of the anomaly. In one embodiment, the electronic alert is configured to be presented in a user interface on a display 2070. Display 2070 is configured to show an indication when the computing component(s) 2003 have been detected to be behaving anomalously based on radiofrequency EMI 2004. For example, computer 2005 composes a signal indicating the detection of the anomaly and transmits it to display 2070, which in response presents the indication for viewing.

In one embodiment, example EMI scanning system 2000 is implemented using a computing system that is configured and/or programmed as a special purpose computing device(s) with one or more of the example systems and methods described herein, and/or equivalents. The computing system may include a computer 2005 that includes at least one hardware processor 2010, a memory 2015, and input/output ports 2020 operably connected by a bus 2025. In one example, the computer 2005 may include expansion card antenna EMI fingerprinting logic 2030 configured to facilitate EMI fingerprint characterization of a target computing system using a specialized antenna expansion card, similar to the logic for performance of an EMI fingerprinting scan of a target computing system using broadband antenna as discussed above, and to the systems and devices described with reference to FIGS. 1-19.

In different examples, the logic 2030 may be implemented in hardware, one or more non-transitory computer-readable media 2037 with stored instructions, firmware, and/or combinations thereof. While the logic 2030 is illustrated as a hardware component attached to the bus 2025, it is to be appreciated that in other embodiments, the logic 2030 could be implemented in the processor 2010, stored in memory 2015, or stored in disk 2035.

In one embodiment, logic 2030 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate EMI fingerprint characterization of a target computing system using a specialized antenna expansion card. The means may also be implemented as stored computer executable instructions that are presented to computer 2005 as data 2040 that are temporarily stored in memory 2015 and then executed by processor 2010.

Logic 2030 may also provide means (e.g., hardware, non-transitory computer-readable medium that stores executable instructions, firmware) for performing one or more of the disclosed functions and/or combinations of the functions.

Generally describing an example configuration of the computer 2005, the processor 2010 may be a variety of various processors including dual microprocessor and other multi-processor architectures. A memory 2015 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 2035 may be operably connected to the computer 2005 via, for example, an input/output (I/O) interface (e.g., card, device) 2045 and an input/output port 2020 that are controlled by at least an input/output (I/O) controller 2047. The disk 2035 may be, for example, a magnetic disk drive, a solid-state drive, a floppy disk drive, a tape drive, a Zip drive, a flash memory card, a memory stick, and so on. Furthermore, the disk 2035 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 2015 can store a process 2050 and/or a data 2040, for example. The disk 2035 and/or the memory 2015 can store an operating system that controls and allocates resources of the computer 2005.

The computer 2005 may interact with, control, and/or be controlled by input/output (I/O) devices via the input/output (I/O) controller 2047, the I/O interfaces 2045, and the input/output ports 2020. The input/output devices include radio receiver 2001. Input/output devices may include, for example, one or more network devices 2055, displays 2070, printers 2072 (such as inkjet, laser, or 3D printers), audio output devices 2074 (such as speakers or headphones), text input devices 2080 (such as keyboards), cursor control devices 2082 for pointing and selection inputs (such as mice, trackballs, touch screens, joysticks, pointing sticks, electronic styluses, electronic pen tablets), audio input devices 2084 (such as microphones or external audio players), video input devices 2086 (such as video and still cameras, or external video players), image scanners 2088, video cards (not shown), disks 2035, and so on. The input/output ports 2020 may include, for example, serial ports, parallel ports, and USB ports.

The computer 2005 can operate in a network environment and thus may be connected to the network devices 2055 via the I/O interfaces 2045, and/or the I/O ports 2020. Through the network devices 2055, the computer 2005 may interact with a network 2060. Through the network 2060, the computer 2005 may be logically connected to remote computers 2065. In one embodiment, the computer 2005 may be connected to target computer system 1400. Networks with which the computer 2005 may interact include, but are not limited to, a local area network (LAN), a wide area network (WAN), and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A method, comprising:
causing a target computer system to execute a test pattern of computer operations;
taking readings of radiofrequency EMI through a broadband antenna card that is installed within a chassis of the target computer system, wherein the radiofrequency EMI is generated by the target computer system during execution of the test pattern;
detecting that hardware of the target computer system is behaving abnormally based on a dissimilarity between the readings of radiofrequency EMI and radiofrequency EMI for nominal operation of a reference computer system; and
generating an electronic alert that the hardware of the target computer system is behaving anomalously.

2. The method of claim 1 further comprising installing the broadband antenna card within the chassis in an expansion slot of the target computing device, wherein when installed, a position of the broadband antenna card is mechanically registered on an expansion connector of the expansion slot.

3. The method of claim 1, further comprising installing the broadband antenna card within the chassis in a hard disk drive bay, wherein when installed, a position of the broadband antenna card is mechanically registered on one or more physical features of the disk drive slot.

4. The method of claim 1, further comprising removing the broadband antenna card from the chassis of the target computer system after generating the electronic alert.

5. The method of claim 1, further comprising, in response to the electronic alert, automatically taking the target computer system out of service.

6. The method of claim 1, further comprising automatically initiating the execution of the test pattern in the target computer system and EMI scanning of the target computer on a repeated schedule.

7. The method of claim 1, further comprising automatically initiating the execution of the test pattern in the target computer system by delivering a test command to management logic of the target computer system.

8. The method of claim 1, further comprising assembling the broadband antenna card to cause the broadband antenna card to have:
a nonconductive frame that has a dummy edge finger configured for mechanically engaging an expansion connector of the expansion slot;
a planar antenna printed in conductive material on a dielectric substrate, wherein the planar antenna is supported by the nonconductive frame in a location that is offset laterally from the dummy edge finger towards a center of the expansion slot for additional clear space from additional expansion cards in adjacent expansion slots; and
a radiofrequency connector electrically connected to the planar antenna and to the EMI scanning system.

9. The method of claim 1, wherein taking readings of the radiofrequency EMI further comprises:
dividing a broadband spectrum of the radiofrequency EMI into a plurality of frequency bins; and
sampling amplitude values from pre-selected frequency bins of the plurality of frequency bins that are selected to be representative of the reference computer system to form the readings of the radiofrequency EMI, wherein the readings are formatted as a multivariate time series of the amplitude values from the pre-selected frequency bins.

10. The method of claim 1, further comprising:
detecting that the target computer system is compromised in a particular way, wherein the particular way in which the target computer system is compromised is one of (i) incipient failure of a component, (ii) a spychip in a component, or (iii) inclusion of a counterfeit component; and
including in the electronic alert an indication that the target computer system is compromised in the particular way.

11. An EMI monitoring system, comprising:
an EMI scanning computer;
a target computer;
a broadband antenna card installed in an expansion slot within a chassis of the target computer;
a radio receiver electrically connected to the broadband antenna card and communicably coupled to the EMI scanning computer; and
one or more non-transitory computer-readable media including computer-executable instructions stored thereon that, when executed by the EMI monitoring system, cause:
the target computer to execute a test pattern of computer operations;
the EMI scanning computer to take readings from the radio receiver of EMI sensed by the broadband antenna card within the chassis of the target computer during execution of the test pattern;
the EMI scanning computer to detect whether the target computer is emitting anomalous EMI based on a dissimilarity between the readings of EMI and EMI for nominal operation of a reference computer; and
the EMI scanning computer to generate an electronic alert that indicates whether the target computer is emitting anomalous EMI.

12. The EMI monitoring system of claim 11, wherein the broadband antenna card is installed in an expansion slot of the target computer.

13. The EMI monitoring system of claim 12, wherein the broadband antenna card is an assembly comprising:
a nonconductive frame that has a dummy edge finger configured for mechanically engaging an expansion connector of the expansion slot;
a monopole antenna supported by the nonconductive frame in a location that is offset laterally from the dummy edge finger towards a center of the expansion slot; and
a radiofrequency connector electrically connected to the monopole antenna and to the radio receiver.

14. The EMI monitoring system of claim 11, further comprising a management network communicably coupling the EMI scanning computer and the target computer, wherein the instructions further cause:
the target computer to initiate execution of the test pattern in response to a test command received through the management network; and
the EMI scanning computer to initiate the taking of the readings in response to a scan command received through the management network.

15. The EMI monitoring system of claim 11, further comprising:
one or more additional target computers;
one or more additional broadband antenna cards installed within the chassis of the additional target computers;
wherein the radio receiver is electrically connected to the additional broadband antenna cards, and
wherein the radio receiver is configured to automatically switch between the broadband antenna cards in response to a switch command.

16. An EMI scanning system, comprising:
an EMI scanning computer;
one or more broadband antenna cards configured to be installed in an expansion slot of a target computer;
a radio receiver electrically connected to the broadband antenna cards and communicably coupled to the EMI scanning computer; and
one or more non-transitory computer readable media including computer-executable instructions stored thereon that, when executed by the EMI scanning computer cause the EMI scanning computer to:
take readings from the radio receiver of EMI sensed by one of the broadband antenna cards within a chassis of the target computer during execution by the target computer of a test pattern of computer operations;
detect that the target computer is emitting anomalous EMI based on a dissimilarity between the readings of EMI and EMI for nominal operation of a reference computer; and
generate an electronic alert that the target computer is emitting anomalous EMI.

17. The EMI monitoring system of claim 16, wherein the broadband antenna cards individually comprise:
a nonconductive frame that has a dummy edge finger configured for mechanically engaging an expansion connector of the expansion slot;
a monopole antenna supported by the nonconductive frame near a lateral center of the expansion slot; and
a radiofrequency connector electrically connected to the monopole antenna and to the radio receiver.

18. The EMI monitoring system of claim 17, wherein the monopole antenna is a planar antenna that is configured to gather broadband radiofrequency emissions, the monopole antenna comprising:
a dielectric substrate conforming to dimensional specifications of a low-profile PCIe expansion card;
a substantially triangular antenna region printed in conductive material on the dielectric substrate; and
a pair of ground regions printed in the conductive material on the dielectric substrate on opposing sides of the antenna region, wherein gaps between the ground regions and the antenna region progressively widen by a spline curvature of edges of the ground regions away from edges of the antenna region.

19. The EMI monitoring system of claim 16, wherein the instructions for taking readings further cause the EMI scanning computer to:
divide a broadband spectrum of the radiofrequency EMI into a plurality of frequency bins; and
sample amplitude values from pre-selected frequency bins of the plurality of frequency bins that are selected to be representative of the reference computer system to form the readings of the radiofrequency EMI.

20. The EMI monitoring system of claim 16, wherein the instructions further cause the execution of the test pattern in the target computer system to be automatically initiated by delivering a test command to management logic of the target computer system.
